(19) United States
(12) Patent Application Publication
(10) Pub. No.: US 2012/0330869 A1
(43) Pub. Date: Dec. 27, 2012

(54) Mental Model Elicitation Device (MMED) Methods and Apparatus

(76) Inventor: Jayson Theordore Durham, Lakeside, CA (US)

(21) Appl. No.: 13/487,249

(22) Filed: Jun. 3, 2012

Related U.S. Application Data
(60) Provisional application No. 61/501,202, filed on Jun. 25, 2011.

(51) Int. Cl. G06N 3/02

(52) U.S. Cl. 706/16

(57) ABSTRACT

A mental-model elicitation process and apparatus, called the Mental-Model Elicitation Device (MMED) is described. The MMED is used to give rise to more effective end-user mental-modeling activities that require executive function and working memory functionality. The method and apparatus is visual analysis based, allowing visual and other sensory representations to be given to thoughts, attitudes, and interpretations of a user about a given visualization of a mental-model, or aggregations of such visualizations and their respective blending. Other configurations of the apparatus and steps of the process may be created without departing from the spirit of the invention as disclosed.

### CROSS-REFERENCE TO RELATED APPLICATIONS

This application claims the benefit of provisional patent application Ser. No. 61/501,202 filed 2011 Jun. 25 by the present inventor.

### FEDERALLY SPONSORED RESEARCH

None.

### SEQUENCE LISTING

None.

### BACKGROUND

### Prior Art

The following is a tabulation of prior art that presently appears most relevant:

U.S. Patents

| Pat. No. | Kind Code | Issue Date | Patentee |
|---|---|---|---|
| 7,136,791 | B2 | 2006-11-14 | Darwent et al. |
| 6,315,569 | B1 | 2001-11-13 | Zaltman |
| 5,436,830 | B1 | 1995-07-25 | Zaltman |

### Nonpatent Literature

Albus, “Mechanisms of planning and problem solving in the brain,” Mathematical Biosciences, 1979 (http://www.isd.mel.nist.gov/documents/albus/Loc_{—}5.pdf)
Albus, “Outline for a Theory of Intelligence,” IEEE Transaction on Systems, Man, and Cybernetics, 1991 (http://www.isd.mel.nist.gov/documents/albus/Loc_{—}206.pdf)
Amanjee et al., “Towards Validating A Framework Of Adaptive Schemata For Entrepreneurial Success,” SA Journal of Industrial Psychology, 2006 (http://sajip.co.za/index.php/sajip/article/view/434/389)
Brandt, “Language and enunciation—A cognitive inquiry with special focus on conceptual integration in semiotic meaning construction,” 2010 (http://www.hum.au.dk/semiotics/docs2/pdf/brandt_line_phd/Brandt_manuscript.pdf)
Cabri et al., “Service-Oriented Agent Methodologies,” 2007 (http://www.agentgroup.unimo.it/MOON/papers/pdf/wetice07.pdf)
Carrillat et al., “Cognitive Segmentation: Modeling the Structure and Content of Customers' Thoughts,” Psychology & Marketing, 2009 (http://class.classmatandread.net/Segmentation/-cognitiveseg.pdf)
Chen, “Exploring Unspoken Words: Using Zmet To Depict Family Vacationer Mental Models,” Proceedings of the First Hospitality and Leisure: Business Advances and Applied Research Conference, 2007 (http://www.ichlar.ch/Proceedings.pdf#page=45)
Christensen and Olson, “Mapping Consumers' Mental Models with ZMET,” Psychology & Marketing, Wiley Periodicals, 2002 (ftp://ftp.cba.uri.edu/Classes/DellaBitta/PRICE%20SEMINAR%20-%20BUS%20610/ZMET/Mapping%20Consumers%92%20Mental%20Models%20with%20ZMET.pdf)
Feldman, “From Molecule to Metaphor: A Neural Theory of Language,” MIT Press, 2006 (http://www.m2mbook.org/reader-roadmap)
Fuller, “Towards a general theory of driver behaviour,” Accident Analysis and Prevention, 2005 (http://p2sl.berkeley.edu/2009-09-09/Fuller%202005%20Towards%20a%20General%20Theory%20of%20Driver%20Behaviour%20%3D%20TheoryofDrivingBehavior.pdf)
Goh and Goh, “The Role Of Analogy In Knowledge, Cognition And Problem-Based Learning,” 2006 (http://www.myrp.sg/ced/research/papers/tlhe2006/The_Role_of_Analogy_Goh_Goh_.pdf)
Kloo and Perner, “Training Theory of Mind and Executive Control: A Tool for Improving School Achievement?,” Mind, Brain, and Education, Blackwell Publishing, 2008 (http://amyalexander.wiki.westga.edu/file/view/training+theory+of+mind.pdf)
Koltko-Rivera, “The Psychology of Worldviews,” Review of General Psychology, 2004 (http://www.filedby.com/images/creatorsfiles/fpqk%5Btgklh.pdf)
Lengler and Eppler, “Towards A Periodic Table of Visualization Methods for Management,” IASTED Proceedings of the Conference on Graphics and Visualization in Engineering (GVE 2007), 2007 (http://www.visual-literacy.org/periodic_table/periodic_table.pdf; http://www.visual-literacy.org/periodic_table/periodic_table.html)
Mandel, “User/System Interface Design,” Encyclopedia of Information Systems, Volume Four, 2002 (http://www.successpragmatiq.com/yahoo_site_admin/assets/docs/Mandel-APEncyclopedia.pdf)
McKeon, “Harnessing the information ecosystem with wiki-based visualization dashboards,” IEEE Transactions on Visualization and Computer Graphics, 2009 (http://www.watson.ibm.com/cambridge/Technical_Reports/2009/TR%202009.04Harnessing%20the%20Web.pdf)
Nakamura and Csikszentmihalyi, “Flow Theory and Research,” in Handbook of Positive Psychology, 2nd Edition, (Chapter 18), Oxford University Press, 2009
Nakamura and Csikszentmihalyi, “The Concept of Flow,” in Handbook of Positive Psychology, 1st Edition, (Chapter 7), Oxford University Press, 2002 (http://faculty.stedwards.edu/michaelo/2349/paper1/ConceptOfFlow.pdf)
Podolefsky, “Analogical Scaffolding: Making Meaning in Physics through Representation and Analogy,” PhD Dissertation, 2008 (http://colorado.edu/physics/EducationIssues/podolefsky/Podolefsky_thesis_analogical_scaffolding_final.pdf)
Podolefsky and Finkelstein, “Analogical Scaffolding and the Learning of Abstract Ideas in Physics: An example from electromagnetic waves,” 2007 (http://www.colorado.edu/physics/EducationIssues/analogy/podolefsky_finkelstein_analogical_scaffolding.pdf)
Siemens and Tittenberger, “Handbook of Emerging Technologies for Learning,” March 2009, (http://techcommittee.wikis.msad52.org/file/view/HETL.pdf)
Sims, “Business Objects Delivering Cooperative Objects for Client/Server,” 1994 (http://www.simsassociates.co.uk/book1/business_objects_{—}2004_{—}01_{—}12.htm)
Thagard, “How Brains Make Mental Models,” chapter in L. Magnani et al. (Eds.): Model-Based Reasoning in Science & Technology, 2010 (http://cogsci.uwaterloo.ca/Articles/Thagard.brains-models.2010.pdf)
Weber, “Customer Co-Creation in Innovations: A Protocol for Innovating With End Users,” PhD Dissertation, Eindhoven University of Technology, 2011 (http://alexandria.tue.nl/extra2/710973.pdf)
Zlatev, “Goal-Oriented Design Of Value And Process Models From Patterns,” PhD Dissertation, University of Twente, 2007 (http://doc.utwente.nl/58038/1/thesis_Zlatev.pdf)

### FIELD OF THE INVENTION

This invention relates to a process and apparatus whereby a user specific repository of inter-related mental-models may be established and provide a basis for personal, as well as, shared understanding. More specifically, this invention relates to a process and apparatus whereby personalized and shared common models may be constructed based upon thinking and behavior of operators and end-users.

### BACKGROUND OF THE INVENTION

An ever-increasing information explosion, due to exponential growth of knowledge, and associated technological resources, is accelerating at an unprecedented rate and a root cause of what has been called information overload. This exponential growth of information and knowledge artifacts has also increased a relative lack of awareness of the potential impact of this excess of new knowledge to improving the quality of individual lives. Thus, from the perspective of this unprecedented growth of knowledge and associated resources, new technologies are needed for readily accessing and utilizing this unprecedented amount of readily available knowledge. Without such new devices, individual human beings are confronted with an emerging and growing challenge of actually becoming relatively less literate, relative to this rapid expansion of human knowledge. In other words, humanity is confronted with a new “literacy crisis” that is due to the lack of new and improved types of technologies that enhance, extend, train, and, ultimately, help adapt the organic neurocognitive capacities of individuals to this newly emerging knowledge-rich context that is ever-growing, global in scale, and nearly instantaneously accessible in time.

The typical person is exposed to numerous sources of knowledge that are attempting to convey information to them. The most obvious sources involve mass media, educational institutions, Internet, and other web-based resources. A growing number of examples help illustrate this emerging need for new technologies that help individuals discover, inter-relate, and utilize this exponentially growing wealth of data, information, and knowledge. Web portals and search engines, such as Yahoo! (http://www.yahoo.com/), Google (http://www.google.com), and Bing (http://www.bing.com/), provide an unprecedented capability to readily discover and retrieve knowledge artifacts that are exposed to the Internet. The Internet itself, World Wide Web (WWW), and proliferation of mobile wireless devices, are additional examples of this historically unprecedented connectivity and respective communications capabilities.

Freely accessible openly-reviewed encyclopedias of unprecedented size and scope, such as Wikipedia (http://en.wikipedia.org) and Scholarpedia (http://www.scholarpedia.org), provide globally reviewed and collaboratively generated bodies of knowledge that again, illustrate the historically unprecedented emerging growth, compilation, and accessibility of human knowledge. Admittedly, the millions (and continuously growing number) of articles in Wikipedia are an illustrative example of how far technology has grown beyond naturally occurring human abilities. The recent web accessibility of patent databases (www.uspto.gov), biomedical databases (http://www.ncbi.nlm.nih.gov/pubmed/), and occupational resources (e.g. CareerOneStop—http://www.careeronestop.org/; http://www.onetonline.org/) are a few additional examples of intellectual capital repositories that can quickly overwhelm the typical individual with the wealth of knowledge and information that is readily available to help enrich their mind and improve their life. A new generation of technologies is needed for better utilizing this excess of human knowledge that has only recently become globally available to the entire human population.

Unless new types of devices and methods are created to help individuals enhance their cognitive performance and associated behavior, this emerging “literacy gap” will continue to widen and further degrade the value realized from the intellectual capital and property associated with this rapidly expanding capability to cumulatively create new knowledge and associated artifacts. In other words, the extent of freely-available knowledge and emerging resources has created a need for new types of devices and methods that help individuals become more aware of how these emerging unprecedented developments can help further improve the utilization, development, and management of mental-models and, in particular, help such individuals utilize, adapt, and evolve such improvements to improve their personal livelihood and physical well-being.

Some knowledge resources and providers are very successful and others are often failures. Two major factors distinguish these types of resources from one another: (1) how well the needs, values, interests, and objectives of the end-user are served and understood, and (2) how well the knowledge provider uses this understanding in making key decisions about what additional knowledge and information needs to be presented to the end-user to maximize the end-user experience and help build a basis of personalized intellectual capital that has lasting value to the specific individual. The creation of satisfied end-users (i.e. customers) is a function of a knowledge provider's (e.g. company's) competence in both factors.

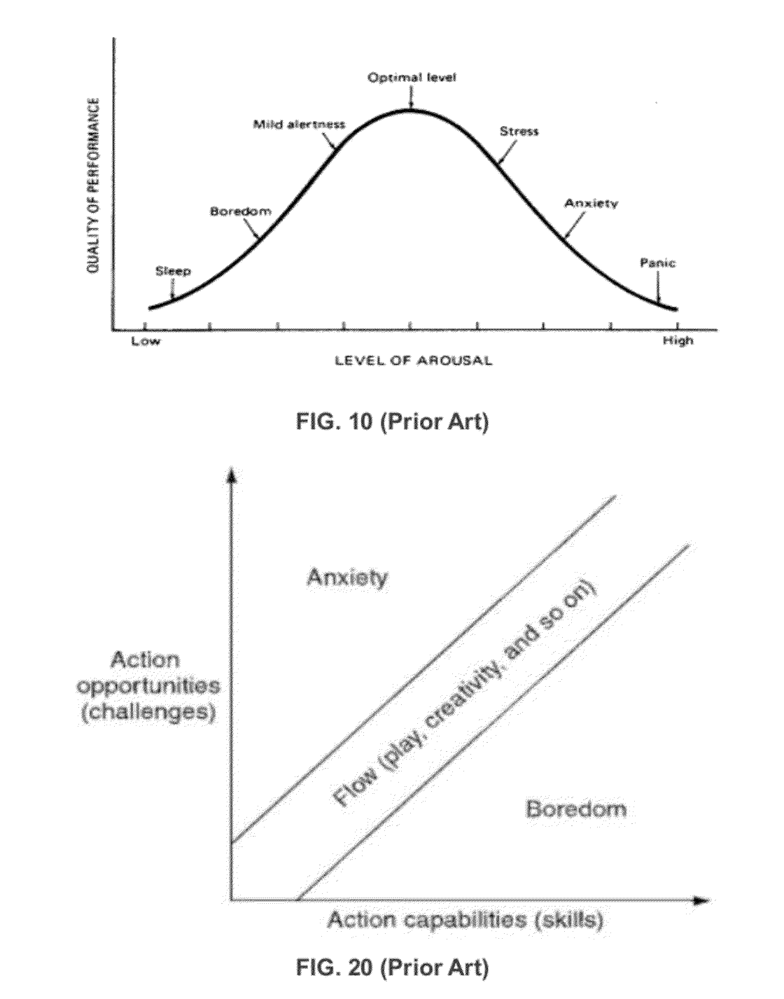

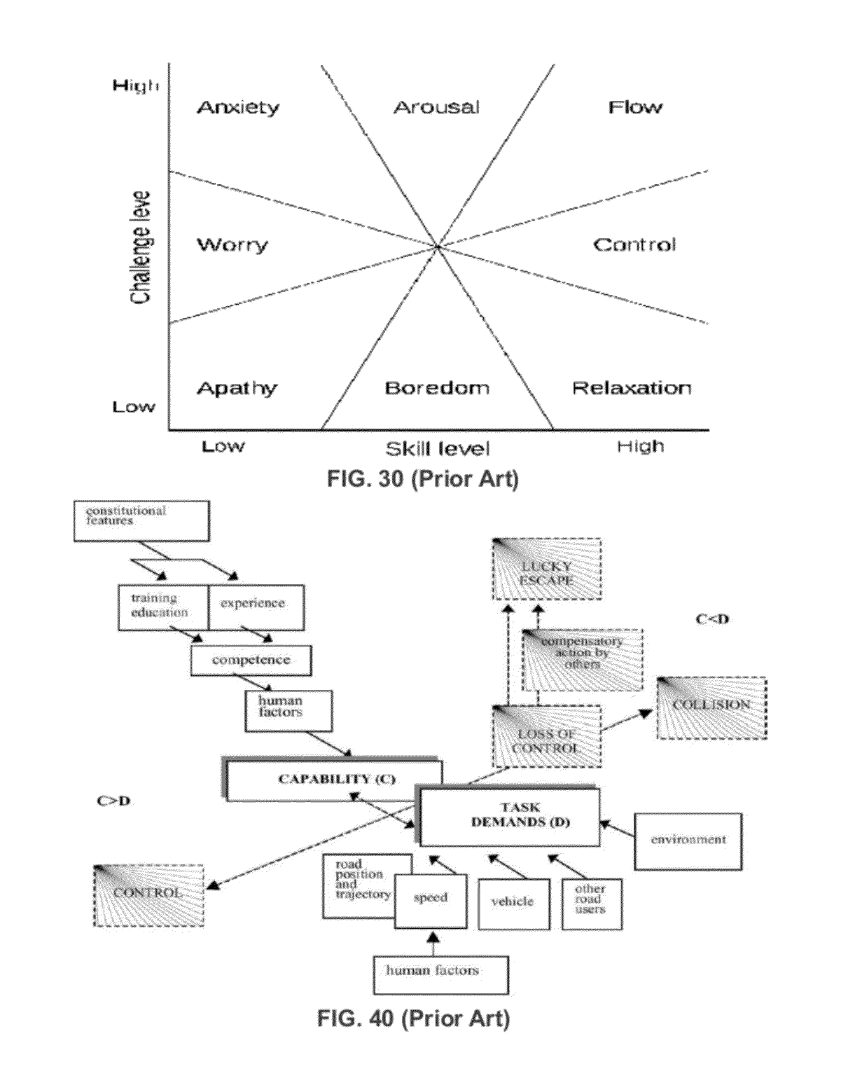

For engaging an individual and maximizing his/her performance, FIGS. 10-40 (note that figures have a default numbering in units of ten) are example prior art that illustrate what has been called “flow” and “being in the zone.” Basically, as seen in FIG. 10, the quality of performance is maximized if the level of a person's arousal is somewhere between a mental state of mild alertness and feeling overly stressed. FIG. 20 is another example visualization that illustrates how this maximized quality of performance is a “zone” between anxiety and boredom, whereby there is a balance between “action opportunities (challenges)” and “action capabilities (skills).” FIG. 30 is another illustration that highlights correspondence of emotional states to challenge-level versus skill-level. FIG. 40 highlights this same type of balance in the context of vehicle driver control versus loss-of-control. As seen in FIG. 40, there are a number of factors that influence and define “capability” (i.e. skill level) as well as, “task demands” (i.e. challenge level). Any device that helps individuals expand their executive function and working memory capabilities, needs to explicitly support the maximization of their personal, as well as, collective team performance where applicable.

The use of multimedia and visualization technology has been growing. End-users and web resources have begun using visually graphic interfaces and supporting technologies as a way to document and communicate important entities and their meaning. Such visually intensive techniques provide further insight into the thought process of such end-users thereby giving a better idea of how a person perceives the visual and associated verbal entities that would appear in typical everyday interactions and activities. In other words, such interfaces enable great visual aid and communication tools. Thus, any device that helps individuals expand their executive function and working memory capabilities, needs to incorporate sensing modalities that include visual aids and communication technologies.

Graphical means for analyzing networks are also known. In the area of network analysis, a number of computer packages exist to give a visual presentation to relationships as they relate to models of both personal and social phenomena. These tools, while used for analysis of such relationships have not been applied to evaluation and relationships among factors in a mental-modeling support setting. Thus, any device that helps individuals expand their executive function and working memory capabilities, needs to incorporate network analysis and applicable emerging analysis technologies. This includes network analysis tools that process representations of both verbal and nonverbal information.

A defining feature of humans is the ability to create tools that extend their organic capacity. This in turn complements another characteristic of human behavior whereby humans use such tools to shape and influence their environment. Three complementary examples help establish a context and illustrate the type of analogous technological improvement needed for improving organically-constrained and limited executive function and working memory capabilities. The three examples are the following: (1) Communication and networking; (2) Timekeeping and time management; (3) Mobility and transport.

Human communication, from an evolutionary perspective, is a quite recent invention for which there continues to be a number of successive improvements. Signaling and oral language, in cooperation with productive social behaviors of associated oral traditions, are example hallmark milestones that have enabled the encoding and communication of useful mental models. Written language, as a more recent improvement, has further expanded the reach and capacity of human communication. With the availability of such physically preserved encodings of human knowledge, the printing press has automated the reproduction of such artifacts. Telecommunications has extended the reach of the transfer of such encodings of human knowledge through the invention of devices that enable more rapid and far reaching transfers of information (e.g. electrical, radio frequency, and optical communications). Information processing technologies, as they are still developing, further improve upon this human ability to encode, communicate, and relate human mental models within an ever growing number of media and possible forms. Thus, the human experience, as understood and communicated through the sensation and perception of individuals, and their interdependent human mental modeling activities, has continued to build upon and extend the enabling elements of organic modeling and communication devices. The orders of complexity for communications related devices have been cumulative over time with even more complex improvements anticipated.

Timekeeping is an analogous and related human activity for which a series of innovative timekeeping-devices have been created for improving the ability to track the passage of time and synchronize collaborative human behaviors. There are terrestrial and biological time keeping devices associated with the seasons, rotation of the earth, and circadian-rhythm. Such naturally occurring and organically indigenous timekeeping capabilities are limited in their ability to aid the managing and orchestrating of human activities. Thus, various types of clocks have continued to improve upon timekeeping from the earliest sundials, water clocks, and hourglasses, to mechanical pendulum and spring clocks, to the latest digital and atomic clocks. The orders of complexity for timekeeping apparatus have also been cumulative over time with even more complex improvements anticipated.

The scope of timekeeping apparatus has also expanded to more explicitly include the value chains and survival value associated with timekeeping. In particular, such devices and associated methods of use are more explicitly and systematically integrated into time-management frameworks. Such technologies span the spectrum from systems designed for individuals, such as “Getting Things Done,” “First Things First,” “Personal organizer,” and “Personal digital assistants,” to more enterprise oriented systems for workflow technology, workflow management, and automation.

The technological evolution of timekeeping devices, from a human task enhancement perspective, illustrates an emergence of an infrastructure comprising of devices and methods that in fact co-develop with the most visible subelements (e.g. clocks with displays, time management systems, workflow management systems). Devices that similarly address and aid other functional classes of neurocognition, such as executive function and working memory, similarly need to be defined and managed within the context of the larger context of their use. In particular, the value of the apparatus can be explicitly tied to the value of such devices, relative to the workflow and associated activities (e.g. interpretation, decisions, and responses), within both individual and collaborative contexts. In other words, better timekeeping helps individuals better manage the scheduling and orchestration of their interdependent activities. This disclosure focuses on improving upon the type of devices that analogously assist and augment executive-function and working-memory capabilities of individuals as a means for further improving and enhancing their task performance capabilities.

Human mobility and transport, from an evolutionary perspective, is another quite recent innovation for which there continues to be a number of successive improvements. Through the continued development of technology, the spatial reach of individuals has expanded from the first wheeled devices, to the train and automobile, to air and space travel. The latest developments in prostheses, bionics, and robotic end-effectors further illustrate the various types of mobility and transport related devices that enhance human performance. There is a need for a type of device that similarly helps individuals discover and explicitly utilize knowledge resources for enhancing their own life experience and associated task performance through integration with enhancement of related executive-function and working memory functionality.

In summary, there is a critical need for improving upon naturally occurring executive function and working memory capabilities. In particular, the improvements need to include associated interdependent activities, such as development, use, and communication of mental models with associated encodings (e.g. visual and verbal artifacts). More specifically, theses improvements need to include devices and methods that explicitly blend together and establish new mental-models that are based on and build upon the canonical standardized reference concepts and models of historically separate, yet fundamentally related domains and areas of work.

Zaltman has patented both a “Metaphor elicitation method and device” (U.S. Pat. No. 5,436,830, issue date 25 Jul. 1995) and “Metaphor elicitation technique with physiological function monitoring” (U.S. Pat. No. 6,315,569, issue date 13 Nov. 2001). This related prior art provides a reference point for the type of devices needed to aid humans in eliciting metaphorical associations. Compilations of this type of ad hoc collections of associations have proven useful for aiding marketing campaigns, for example. Unfortunately, this type of elicitation technology does not address the need for tools and methods that help individuals with the elicitation and relating of canonical standardized reference concepts and models. Thus, this is another example of the lack of technologies that aid and support the explicit grounding of metal models to common reference resources, such as globally accessible, openly reviewed, and nearly instantaneously accessible encyclopedias (e.g. Wikipedia) and similarly useful knowledge retrieval/management resources (e.g. Yahoo!, Google, Google Scholar, Google Patents, USPTO.gov, PubMed, Carrot2, Wikipedia Thesaurus, Wikipedia Miner, Visual wikis, text-to-scene generators, question-answer systems, user profiling interfaces). Goal-driven process management tools also provide examples of resources that would benefit from a mental-model elicitation capability (e.g. MS Sharepoint Balanced-Scorecard Strategy Mapping, KAOS, i*, GBRAM, Tropos).

As with a number of other examples (Chen 2008; Carrillat et al. 2009; Weber 2011), Christensen and Olson (“Mapping Consumers' Mental Models with ZMET,” Psychology & Marketing, Wiley Periodicals, 2002), describe the use of the Zaltman technique (ZMET) for creating ad hoc profiles and consensus maps of samplings of customers. Unfortunately, as mentioned earlier, such results are not explicitly grounded in reference representations and underlying models. Thus, current “mind mapping” technologies produce ad hoc representations of mental models.

Ideally, there should exist improved techniques that focus on interactions with verbal and nonverbal (e.g. visual) representations of canonical and authoritative reference models that represent widely (and easily) recognizable facts within their respective domains. Thus, such elicitation results more readily incorporate and build upon the wealth of readily available knowledge artifacts and associated resources (e.g. Wikipedia, Scholarpedia).

Additionally, such improvements would furthermore leverage techniques such as “analogical scaffolding” (Podolefsky and Finkelstein 2007; Podolefsky 2008) to further support the synthesis (e.g. semiotic blending) of the respective representations and models. In addition to the improvements for marketing research, such well-grounded mental model elicitation would provide an additional benefit of helping individuals to individually and collectively elicit, discover, and synthesize new knowledge that accounts for the comparing and contrasting of representations of commonly accepted and easily recognized reference models. Prior art, such as the ZMET, provides valuable insights and helps make explicit, what is otherwise implicit knowledge. Unfortunately, the results of such prior art do not explicitly support the grounding of their respective results within globally-accessible openly-reviewed resources and knowledgebases.

Sharon Michelle Darwent et al. have patented a “Story-based organizational assessment and effect system” (U.S. Pat. No. 7,136,791, Issue Date 14 Nov. 2006). As highlighted in figure two of the patent, entitled “Information flow during each phase,” the subprocesses of “elicitation and storage” and “sensemaking” are distinct phases relating to embodiments of the patented process. As illustrated in figure three of the patent, entitled “Outputs for each phase,” the output from the elicitation phase feeds into the sensemaking phase. The generation of purposeful stories are example end-results and outcomes of the process. Unfortunately, similar to the case with the Zaltman patent, there is no explicit grounding in reference mental models of common and domain-specific knowledge elements that are fundamental and immediate to the end-user. In other words, this is another example of the lack of aid and support for explicit grounding of such results to common reference resources. Ideally, improvements in elicitation techniques and devices will include narrative elements (e.g. narrative working memory), as well as, techniques and devices for creating the respective knowledge artifacts as a result of the process. This is especially of interest for producing knowledge artifacts for which there are commonly agreed formats and templates (e.g. books, reports, papers, business plans, patents).

The present invention entitled the Mental-Model Elicitation Device (MMED), utilizes a variety of techniques and resources to create such an improved sensory (e.g. visually) and narrative oriented method and apparatus. Example embodiments of the MMED also include creating, updating, and extending repositories, interfaces, and information management tools that collectively improve the executive function and working memory capabilities of one or more individuals. Note that the MMED can also be used to collectively validate the contextual association and orientation of existing predetermined collections of mental models and associated visualizations (e.g. “mind maps,” tag clouds, goal models, activity diagrams).

### BRIEF DESCRIPTION OF THE INVENTION

The Mental-Model Elicitation Device (MMED) process and apparatus provides a way to conduct exploratory and developmental activities which provide reliable and valid end-user information in the form that the users and other stakeholders find helpful. The process and apparatus of the present invention is based on the establishment, adaptation, and evolution of mental-models and associated visualizations used by end-users. For purposes of this application, an “end-user” is an individual whose opinions, observations and sensory input are being elicited. A mental model is an explanation of someone's thought process about how something works in the real world. It is a representation of the surrounding world, the relationships between its various parts and a person's intuitive perception about their own acts and their consequences (http://en.wikipedia.org/wiki/Mental_model). Additionally, mental models can also include cognitive constructs that help shape behavior and define possible approaches to solving problems (akin to a personal algorithm) and carrying out tasks.

For example, a person may see visualizations of a mental model, as provided in FIGS. 10-40, and recognize the meaning of the entities displayed and their fundamental relationships, as intended by the creator of the example visualizations. Thus, the visualizations reinforce agreement between the mental-models that motivate and define the communicated description. Furthermore, the same person may see the collection of visualizations, as provided by FIGS. 10-40, and recognize the intended meaning of bringing the four visualizations together in the order provided. This in turn elicits an aggregate mental model that is an aggregation and semiotic encoding of a larger context defined by the four figures.

More specifically, note that FIGS. 20-40 display three different inter-related visualizations that highlight different aspects of the fundamental tradeoffs between skill level and challenge level. The aggregation of these three visualizations defines and elicits an aggregate mental model that more specifically relates the spectrum of human emotion, as well as, the spectrum of underlying “human factors” that directly relate to this fundamental tradeoff. Thus, this is an example use-case of the MMED device and methods, whereby predetermined visualizations of mental-models are discovered with the aid of knowledge and information discovery technologies. Such visualizations are selected, aggregated, blended, and utilized to establish a context whereby the said aggregation provides a more unified mental model specific to the end-user context. This core synthesis of mental models, also called a blending, is further related to other knowledge artifacts as considered useful or of interest to the end-user (e.g. Wikipedia topics, patents, published papers, web pages, images, videos, etc).

Another key element of this invention is the incorporation of a common sense principle often associated with, and understood as relating to, the “Golden Mean,” “Doctrine of the Mean,” or “Middle Way.” Thus, another way of describing the concept of “flow” and “being in the zone” is to recognize that there is an ideal balance between the extremes of a predetermined dichotomy, or aggregation of dichotomies. In sports terminology, this is analogous to what is known as a sweet-spot “where a combination of factors results in a maximum response for a given amount of effort” (http://en.wikipedia.org/wiki/Sweet_spot_%28sports%29). In terms of the golden mean, this is analogous to “the desirable middle between two extremes, one of excess and the other of deficiency” (http://en.wikipedia.org/wiki/Golden_mean_%28philosophy%29). In other words, the MMED helps users create more explicit, operative, and effectual multi-coordinate (i.e. multi-dichotomy) mental models that represent and reflect their perceptions, cognitive perspectives, paradigms, value systems, and world views.

Thus, the MMED is an apparatus that interfaces with end-users (e.g. customers, stakeholders, and other entities) and utilizes information processing, sensor-net, robotics, automation, artificial intelligence, and other technologies to help automate and streamline the elicitation, development, retrieval, and management of such mental-model aggregations, representations of relatedness, visualizations, semiotic encodings (aka blends), and other related knowledge artifacts that improve self-awareness and facilitate more effective shared collective understandings. In other words, the device and methods, as described herein, address this new need that has recently emerged, due to the benefit of freely available reference knowledge, tools, decision support systems, and knowledge management resources.

The significance of nonverbal communication is widely recognized due to the fact that most communication occurs nonverbally. Thus, individuals tend to “say” and “hear” a great deal more through nonverbal rather than verbal means of communication. However, virtually all mental-model analysis and research tools rely on ad-hoc verbal means of communication such as keyword searches, queries, surveys, face-to-face interactions, and discussions or interest groups.

Because of this reliance on verbally oriented tools, much of the nonverbal elements of what individuals “think,” “say,” and “hear” are not addressed. Thus, current tools and resources often miss important opportunities to understand end-users better and facilitate better communication. As a consequence, the end-users and the knowledge providers serving them become less well off than otherwise possible.

Within Sims1994 (http://www.simsassociates.co.uk/book1/business_objects_{—}2004_{—}01_{—}12.htm), a schematic diagram illustrates the “usability iceberg” (FIG. 12). As discussed in the paper and visually communicated, system usability depends on three factors: (1) Presentation (e.g. how things appear, operational feedback, aesthetics) typically accounts for approximately 10% of the usability of a system; (2) Interaction (e.g. how users make requests, ways of interacting, device mappings, standard menus and dialogs) typically accounts for approximately 30% of the usability of a system; (3) The user's conceptual model (e.g. objects, properties, behaviors, common metaphors) typically accounts for approximately 60% of the usability of a system. Note the value of a mental-model elicitation, assessment, and reengineering/evolution tool that improves upon the ability to dynamically align and evolve a user's conceptual models (e.g. mental models) with the progressively less abstract and more detailed models that might better describe the necessary engineering and implementation details. Sims 1994 (http://www.simsassociates.co.uk/book1/business_objects_{—}2004_{—}01_{—}12.htm) and Mandel 2002 (http://citeseerx.ist.psu.edu/viewdoc/download?doi=10.1.1.124.6582&rep=rep1&type=pdf) provide two different example visualizations of a mental model that captures this interdependency between presentation, interaction, and the user's underlying conceptual modeling space. These figures highlight that for both the verbal and nonverbal communication, successful and meaningful communication requires a solid foundation of interrelated mental models that share common metaphors, mental images, visualizations, properties, and behaviors.

Note that a mental-model elicitation, assessment, and reengineering/evolution tool (i.e. MMED) can assist an end-user with dynamically aligning and evolving the user's conceptual models (e.g. mental models) with successively more explicit and detailed models.

A MMED can also assist end-users in discovering and associating visualizations that capture similarities and differences with diagrams that depict the same type of mental model. Mandel 2002 (http://www.successpragmatiq.com/yahoo_site_admin/assets/docs/Mandel-APEncyclopedia.pdf) is a publication with such an example of a different visualization of the “usability iceberg.” In this example use-case, the end-user might use the MMED to explicitly note the equivalence between “object properties” and a “user's conceptual model,” while at the same time noting the differences. Alternatively, an embodiment of the MMED may provide suggested feature similarities and differences that have been algorithmically prescored and subsequently collectively rated by other end-users. Such scores may also be broken out into subtypes according to user selected conditions (e.g. scoring by other users who have a similar user profile or user-selected group of features and attributes).

Thus, as the example user interaction with “utility iceberg” diagrams illustrate, the perceptual and related cognitive abilities of an end-user are a foundational dependent variable for mental-modeling related activities. Visualizations of such valuable knowledge are typically incorporated within the knowledgebase of a MMED device. Many consider this the basis of “semantic grounding,” which is another way of describing how words and images have meaning for an individual person and relate to their personal (i.e. most immediate) experience. Instincts, innate behavior, and archetypes provide another way of describing this physical substrate and basis from which personal experience and associated mental-models are grounded and genetically (i.e. biologically) conditioned.

To extend our example use-case of an example MMED embodiment, a separate set of example mental models and visualizations may be presented to the user to illustrate how such cognition and perception depends on a substrate of neurons and associated electrochemistry. Feldman 2006 (http://www.m2mbook.org/reader-roadmap) is a reference with visualizations that provide this type of illustration of how the physical (e.g. biological) substrate impacts the ability to form and manage mental models that are the basis of human ideas, understanding, and communication. Indeed, as noted in Feldman 2006, “the embodied theory of meaning suggests that the child needs to have conceptual structures or schema for understanding experience before the worlds of labeling them can make sense.” The interactive visual communication typically provides a new set of schematic diagrams that further illustrate how ideas and communication inherently depend on the underlying neurons and associated biochemistry. Thus, the MMED user learns through interactively interrelating visualizations of mental models that communicate an understanding of how thought is a structured neural activity, and language is inseparable from thought and experience.

Additional schematic diagrams may further illustrate the role of schema and frames within the context of mental models and associated cognitive modeling subelements. These additional visualizations help communicate that this “embodied theory of meaning suggests that a child needs to have conceptual structures or schema for understanding experience before the worlds for labeling them can make sense” (Feldman2006). Thus, the methods and apparatus disclosed herein help to interactively provide a more rigorous and systematic evolution of an end-user's “understanding of experience.” As highlighted previously, this is done by explicitly introducing, aggregating, conceptually-mixing, and synthesizing standardized references (i.e. “conceptual structures and schema”) throughout the various developmental stages of an individual's lifespan development. Thus, the end-user more naturally thinks and acts (i.e. performs) in terms of the commonly accepted knowledge artifacts (i.e. visualizations of mental models).

Within the context of the above paragraphs and visualizations of related mental models, we continue on with our example MMED session. Amanjee et al. 2006 (http://sajip.co.za/index.php/sajip/article/view/434/389) and McKeon 2009 (http://www.watson.ibm.com/cambridge/Technical_Reports/2009/TR%202009.04Harnessing%20the%20Web.pdf) provide additional example mental model visualizations that are typically incorporated within the knowledgebase of an example MMED embodiment.

Amanjee et al. 2006 provides an analogy of a “lens” whereby adaptive schema help optimize an individual's life experiences in such a way that the associated inter-dependent activities of interpretation, decisions, and responses are clarified and, thus, optimized. Note that the process is self-referential and that in fact the mental models (e.g. visualizations, schema) and activities (e.g. interpretation, decisions, and responses) are inter-dependent elements that adapt and evolve over time. McKeon2009 illustrates that current web-based and mobile technologies provide a rich user-interface for facilitating this type of incremental, evolutionary, self-adaptive process that helps develop and fine-tune the overall process of knowledge elicitation and discovery. A key feature of the MMED is to help the user explicitly understand and recognize that preconditioned and physical (e.g. neurological) interdependencies directly relate to and impact their perception, cognition, and subsequent human activities.

Through the use of a variety of visualizations, our example MMED interactions illustrate how the device leverages what some call the “hermeneutic circle.” As highlighted and illustrated in a number of references (e.g. http://www.webalice.it/melabosch/Contenidos/ISKOMontreal2008MazzBosch.pdf; http://en.wikipedia.org/wiki/Hermeneutic_circle), all interpretations depend on some sort of underlying explanation for which there is a predetermined basis of understanding. A new interpretation in turn provides a new understanding that undermines the process as previously known. Thus, understanding, explanation, and interpretation are interdependent elements within a cyclic process that evolves over time. Thus, there is an inter-dependent cycle whereby actions that change the environment in turn change the context of the control process that in turn changes the interpretation, representation, and subsequent predictions.

Within an interactive session with the MMED, the user would typically be exposed to illustrations that come from different domains and areas of work. For example, the fundamental visual similarities with “hermeneutic circle” visualizations and biologically inspired “hierarchical control” visualizations are of particular interest due to the close resemblance of such “hermeneutic circle” visualizations to biologically inspired reference models developed by James Albus and others for modeling hierarchical control and intelligent systems. Through interaction with a MMED, the user learns to proactively evolve the basis of their understanding and successively synthesize new understandings (i.e. mental models) through exercising and leveraging the cyclic interdependencies of understanding, explanation, and interpretation. In terms of a typical MMED, this mindset is enabled by directly associating “hierarchical control” mental models with “hermeneutic circle” mental models, as illustrated in the example use-case.

Thus, the MMED is not specific to a particular understanding, explanation, or interpretation. The MMED works to facilitate elicitation of models that relate to supporting end-user activities that improve the performance and work towards an end-user experiencing “flow” and “being in the zone.” In other words, the MMED helps users clarify, refine, and evolve what works for them.

An analogy to blindness and visualization helps illustrate the need and value of MMED technology. Within the context of theory of mind, mentalization, and attachment theory, the concept of mind-blindness has been described as “an inability to develop an awareness of what is in the mind of another human. It is not necessarily caused by an inability to imagine an answer, but is often due to not being able to gather enough information to work out which of the many possible answers is correct. Mind-blindness is the opposite of empathy. Simon Baron-Cohen was the first person to use the term ‘mind-blindness’ to help understand some of the problems encountered by people with autism or Asperger syndrome or other developmental disorders.” (http://en.wikipedia.org/wiki/Mind-blindness).

Thus, the MMED provides an analogy of a “self-adaptive lens” that facilitates awareness, conceptual clarification, and “bringing into focus” elements of mental modeling activities (e.g. mental models and their visualizations). Thus, interaction with the MMED facilitates the elicitation, discovery, and working-memory retrieval of mental models for respective end-users within the context of a MMED resource that may be shared among collections of MMED users and visualizations of their mental models.

Another example analogy is “face blindness,” also called prosopagnosia, which is a disorder of face perception where the ability to recognize faces is impaired, while the ability to recognize other objects may be relatively intact. This is clearly a type of “conceptual blindness.” Through the use of the MMED, a user may be presented with visualizations of mental models that are considered common knowledge. The inability of the user to relate to such commonly recognized models is considered an indication of a possible disorder of neurocognitive perception. Alternatively, the MMED can aid an operator in recognizing a special talent for quickly recognizing and readily understanding visualizations of such mental constructs.

For the MMED, executive-function and working-memory are considered to be analogous neurological subelements for which there are biomimetic (e.g. neurological, neurocognitive), systems (e.g. systems engineering, systems theory, service oriented architecture, enterprise architecture, business process management), and computational (e.g. associative memory, object-oriented analysis and design) correlate technologies. Thus, the MMED is an apparatus that helps individuals to discover, relate, and utilize recently developed concepts, knowledge, and associated resources for assessing and enhancing their own corresponding executive-function and working-memory capabilities. For example, using the MMED, emerging discoveries and knowledge would be explicitly associated with new and nonobvious assemblages of metal-models that help an end-user better discover and manage emerging interdependent knowledge with respect to their individual quality of life and associated lifestyle.

As highlighted earlier, within the example use-case, the MMED may include example embodiments that utilize biologically inspired cognitive architectures (www.bicasociety.org) that reflect, mimic, and to the extent possible, mirror the human correlates of executive function and working memory. As such, the MMED can be viewed as a technology that extends and augments naturally occurring executive function and working memory capabilities to better support such human activities (e.g. interpretation, decisions, and responses) that impact an individual's performance and experience of “flow” or “being in the zone.” Within this context, the MMED becomes a critical tool that becomes useful for accelerating knowledge discovery, knowledge transfer, and knowledge assimilation for an individual, as well as, for groups of individuals that collectively and collaboratively utilize embodiments of MMED technology.

Cabri 2007 (http://www.agentgroup.unimo.it/MOON/papers/pdf/wetice07.pdf) and Zlatev 2007 (http://doc.utwente.nl/58038/1/thesis_Zlatev.pdf) provide example visualizations that may be accessed within a MMED session (i.e. use-case). In this type of session interaction, the MMED interactively communicates how a family of web services (e.g. discovering, matching, planning, composing) can help elicit and make explicit a collection of interdependent user goals. Thus, this type of session introduces the users to mental models that illustrate how the user can create personalized instantiations of mental models (e.g. goal model, activity models) that, in turn, provide a basis for building their own personalized process models that are useful for managing activities that are composed of interdependent tasks, within their own lives.

Thus, the user interactively and adaptively learns how the MMED provides a web service for selecting from a library of patterns (e.g. reference models) for evaluation and synthesis of an explicit “aggregate solution.” Thus, the MMED elicits the tacit knowledge that motivates the aggregation of such elements into blends of concepts that more explicitly represent the synthesis of such concepts into new representations that reflect and represent the motivating tacit knowledge. For purposes of this disclosure, note that the final resulting synthesis is in one sense, a conceptual mixture-model and blend of reusable reference schemata that explicitly relate “goal models” with “activity models” that enable the achievement of the respective goals, as represented within the respective goal model and mapping to respective activities.

Siemens and Tittenberger, March 2009, “Handbook of Emerging Technologies for Learning,” (http://techcommittee.wikis.msad52.org/file/view/HETL.pdf), further highlight the need and utility of the MMED. In today's context, informational knowledge artifacts are scattered across a broad spectrum of resources (e.g. books, reports, courses, papers, digital libraries, repositories, web sites). Thus, as visually highlighted within the reference, an individual's “sensemaking activities” have evolved from understanding a body of relatively stable coherent information, to assessing and making more explicit the coherence of the wealth of information and knowledge that is readily available from a broad variety of resources. For example, the primary learning task of the individual has evolved from the study of knowledge (i.e. epistemology) to the more immediate context of their being (i.e. ontology). Thus, the focus has shifted away from specific “products and states” to contextually relevant “process and capacity.”

This further illustrates the trend whereby technology and ideas have continued to increase the control of the individual and the individual's “ability to create.” As also highlighted within the reference, this historical shift has created a new context of “connectivism” that helps inter-relate, bring together, and cross-leverage a number of different domains (e.g. External/Social, Neural, Conceptual). Again, through an interactive session with the MMED, the user is exposed to the respective visualizations that communicate features of a useful and timely mental model. Within our example session, the MMED would also incorporate individual and collective feedback that further elaborates on this trend towards a new context of “connectivism.”

Within this example session, a related set of visualizations may help suggest to the user that the visualizations of other mental models may be related to this trend. For example, a diagram from a Wikipedia article (http://en.wikipedia.org/wiki/Active_listening) illustrates how the MMED facilitates a type of “active listening” whereby a user works to observe and view the mental models and related knowledge artifacts (e.g. schematic visualizations) as descriptive elements (e.g. illustrations). Thus, through analogous phases of repeating, paraphrasing, and reflecting, an individual MMED user is able to render an aggregate and composite collection of mental models in the user's own words, sentence structure, and mental imagery (e.g. visualizations). For each phase of the analogous “MMED active listening” and “sensemaking” process, “perceiving, paying attention, and remembering” are similarly foundational activities within each phase. This more phenomenological descriptive approach and process is an example mechanism used by the MMED to help align and harmonize the immediate experience and worldview of an end-user with the schematic visualizations and other mental images of reference mental models that facilitate more explicit understanding and “symbol grounding.”

More specifically, the MMED utilizes predetermined schematic representations (e.g. visualizations) of mental models to elicit new understandings from end-users. This shift in understanding enables the further elicitation of yet more mental models that build on results from previous mental-model elicitation results. As illustrated by Koltko-Rivera, “The Psychology of Worldviews,” 2004 (http://www.filedby.com/images/creatorsfiles/fpqk%5Btgklh.pdf), the objective is to evolve the world view of the end-user towards an aggregate mental model that helps the end-user “piece together” the otherwise more disparate schematic visualizations of the rapidly expanding number of mental models that are readily available. Thus, the MMED provides a number of baseline (i.e. canonical) mental models that explicitly establish a more readily coherent conceptual foundation for incrementally pulling together the otherwise overwhelming number of schematic visualizations that are readily available. As noted earlier, the references cited within this disclosure provide examples of such schematic visualizations of mental models.

Also note that an example embodiment of the MMED may utilize and produce knowledge artifacts that are of the same style and analogous to what are commonly known as picture books, comic books, or graphic novels. Thus, the use of speech balloons, captions, or other cues help facilitate a dialogue among the constituent characters and agents of a highly visualized storyline that explains a mental construct that is composed of an aggregation of communicative visualizations of underlying mental models.

An example related-patents tag cloud enclosed within this disclosure (Appendix A), illustrates a rich history of the types of previously patented devices for which the MMED is considered a significant improvement. The key common element of these examples is the teaching of segmentation, semiotic encoding (aka blending), and manipulation of inter-related and inter-dependent mental models. The examples also illustrate that such devices help individuals develop their executive function and working memory capabilities, as an integral element of their human development. The MMED improves upon this rich history of prior art technology by leveraging recently developed knowledge, and associated resources, that are continuing to expand at an unprecedented rate.

The MMED facilitates display, manipulation, and management of mental images (e.g. visualizations) of recently developed and commonly accepted mental models while working in combination with emerging information processing technologies (e.g. search engines, wikis, content management systems, learning management systems). Thus, the MMED and associated methods-of-use are a type of technology that extends human performance beyond the now organically-limited naturally-occurring capabilities of both executive function and working memory. The exponential growth of available visualizations of mental models and associated knowledge resources, provides a correspondingly exponential number of possibilities that far exceed the limited capacity of the organically-constrained human brain and sensory interface.

Of particular interest and value for this new technology are the use of existing imagery-oriented mental-modeling artifacts, crowdsourcing, computer-supported collaboration, participatory design, computer supported cooperative work, and related resources to facilitate the transition of otherwise less-common knowledge into a more commonly understood and recognized format. As noted earlier, this type of elicitation process more naturally facilitates the evolution of individual and collective worldviews and contexts of human understanding.

Visualizations of concepts and mental models (in this case digital images) are a necessary part of the present invention. A visualization is a predetermined external or internal mental pictorial representation of an aggregation of concepts or mental models. In other words, displayable images that communicate information relating to an aggregation of predetermined concepts or mental models, are a necessary part of this invention. Symbols, signs, schematics, pictograms, diagrams, depictions, and mental model representations are considered types of visualization techniques and artifacts.

For example, a spatial or temporal arrangement of words, symbols, icons, signs, and other meaningful entities visually encodes the aggregated meaning of such collections. The various ways of constructing and displaying “tag clouds,” further illustrate this innate human behavior of visually associating such representative entities. Thus, visualizations include graphical views and displays of verbal representations of concepts and mental models.

The aesthetics of typography further illustrate the additional value added by encoding the visual presentation of verbal information. In particular, as common with tag clouds, just the change in position, spatial-temporal clustering, size, style, or color of phrases, words, and letters can encode the salience of particular concepts and mental models, engendering and eliciting a new mental model that comprises their visually encoded aggregation and display. This type of encoding is also effective for the visualization of mental models associated with lexicons, semantic networks, and concept maps.

The MMED may also utilize an ever growing assortment of mapping techniques, software, and supporting resources. Such existing mental model visualization resources include graphical modeling languages, argument maps, topic maps, mind maps, cognitive maps, conceptual graphs, outlines, swim lanes, activity diagrams, flowcharts, semantic networks, and their associated supporting tool suites that help generate the respective visualizations of mental models.

As the previous paragraphs illustrate, there is no lack of visualization techniques and types of visualization methods. Lengler and Eppler, “Towards A Periodic Table of Visualization Methods for Management,” 2007 (http://www.visual-literacy.org/periodic_table/periodic_table.pdf; http://www.visual-literacy.org/periodic_table/periodic_table.html) provide a visualization of a mental model that utilizes an analogy with the periodic table of the elements to visually communicate the inter-relatedness of the broad spectrum of visualization methods. Note that this visualization encodes a catalog and taxonomy of types of visualizations in a manner that is analogous to the typical display of the chemical elements.

For the present invention, the utilization of such a categorization of types of visualization methods further highlights the value of the MMED. One feature of the MMED includes the elicitation and discovery of which types of visualizations an end-user tends to prefer for visually communicating their own particular and user specified mental models. Thus, a functional element of the MMED includes the explicit cataloging, classification, and categorization of user visualizations. Degrees of relatedness to predetermined elements of such aggregations, categorizations, taxonomies, and ontologies are also calculated to aid the elicitation process. A key feature and function of the MMED is to provide a commonly agreed canonical basis of visualizations from which individuals are able to relate and reconcile their own personal mental models that are made more explicit through the use of MMED technology.

Note that the agreed “ground truth” is subject to the “hermeneutic circle,” as discussed earlier. Thus, the type of grounding provided by the MMED is more analogous to an equilibrium state that is expected to adapt and evolve over time, due to the cumulative refinements and interaction with MMED users. More specifically, the MMED serves as a tool and reciprocally employs technologies from related domains and disciplines, such as data visualization, information visualization, information graphics, scientific visualization, visual analytics, data presentation architecture, diagrammatic reasoning, and visual reasoning. The technology disclosed herein provides the respective mental modeling support tools and methods that facilitate a grounding in commonly accepted mental models through the collaborative elicitation process, as disclosed.

A mental image is a key element used during the course of the present invention. A mental image is an experience that, on most occasions, significantly resembles the experience of perceiving some object, event, or scene, but occurs when the relevant object, event, or scene is not actually present to the senses. As contemporary researchers use the expression, mental images (or mental imagery) can occur in the form of any sense, so that we may experience auditory images, olfactory images, and so forth. However, the vast majority of philosophical and scientific investigations of the topic focus upon visual mental imagery (http://en.wikipedia.org/wiki/Mental_image).

All sensory images are important nonverbal means of communication. Multiple sensory images are also important in the present invention since one sensory image such as sight can trigger the experience of another sensory image such as taste. This kind of connection among senses is known technically as synesthesia.

Visualizations of concepts and mental models provide sensory images that evoke mental images within the immediate experience of the MMED user. Supporting verbal communication complements the corresponding visual depictions and illustrations. Together, the combination of visual and verbal information provides an opportunity for the user to register degrees and types of agreement or disagreement with the message being communicated. Due to the information being grounded in commonly accepted facts and standardized reference models, the MMED can provide additional information for elements of the visual presentations that are not clearly understood by the end user. Aggregations of such inter-related visualizations and their supporting information elements, provide a more well defined user-specific package (e.g. aggregation and supporting information) that better represents and communicates the reference knowledge of interest and value to the end user.

As the user reviews and explores knowledge of interest, mental images are triggered and contribute to the user experience. This assemblage of mental imagery, as noted by the user and recorded by the MMED, indicates degrees of agreement, correlation, and correspondence to the reference knowledge artifacts that are being explored and under review. Spontaneous or seemingly unrelated mental imagery that is evoked by interaction with the MMED is noted with feedback and interaction submitted through the user interface. Throughout an interactive session, relationships with user mental models, via knowledge artifacts shared between the user and the MMED, are recorded. This elicited feedback is subsequently utilized by the device to enrich interaction with the user and aid in the development of user mental models that are well grounded in one or more standardized reference knowledge bases that provide a foundation for perceived, as well as actual, commonality of canonical standardized reference models.

Mental imagery is known to evoke emotional states or feelings. Much of the affect and motivation of an individual results from this more fundamental and immediate element of human experience. As previously discussed, the goal is to impact and improve the resulting behavior of the user such that the MMED is able to contribute toward a user experiencing flow and “being in the zone.” For a variety of reasons, a person may have deep rooted emotional associations with elements of mental models or related visualizations. While noting and recording the relatedness of mental model visualization to user mental images, emotional associations are also noted and recorded. Eliciting a more explicit awareness of the co-occurrence of emotions and feelings will help the user identify factors that impact the actual improvement to the activities that relate to the associated mental visualizations, images, and associated models.

Emotional states or feelings can evoke mental images and sensations (e.g. fight-or-flight response, sympathetic nervous system response). Thus, states of emotion and feelings evoked by mental images resulting from the given visual stimuli, may in turn evoke mental images that relate more with the emotions and feelings, versus the visualization that relates to a given reference canonical mental model. Where possible, the user works to differentiate which mental imagery goes with which type of stimuli. Mental images that are representative of or associated with “being bored to sleep,” are obviously not going to positively contribute towards a sense of flow and maximized performance level. Similarly, mental images that are associated with anxiety and panic are also going to have a negative impact on user performance level.

Thus, emotions and feelings can be relatively independent of more cognitive, conceptual understandings and associated mental models. Physiological monitoring of users is an optional feature that can aid in identifying emotions and feelings for which the user may not otherwise identify potentially performance limiting responses. The goal is to elicit the entire spectrum of associations and responses while providing methods and devices for establishing a more well developed mental model that contributes toward maximizing “flow” and “being in the zone” experiences for the end user.

A goal or objective is a desired result a person or a system envisions, plans and commits to achieve—a personal or organizational desired end-point in some sort of assumed development (http://en.wikipedia.org/wiki/Goal). From an evolutionary psychology perspective, the most primary goal of interest is survival and “successful living” (e.g. the experience of flow and “being in the zone”). As noted above, the elicitation of the elements of such high-value goals engenders the awareness and association of a number of other interdependent and related influences that contribute in positive and negative ways. The MMED is a tool that helps catalog, categorize, analyze, and manage the volume and open-endedness of such articulated elements.

Within the context of the MMED, the objective and end goal is to help elicit an awareness that facilitates the production of end-user associations that influence the ability to experience flow, relative to an item of interest, such as the visualization of a mental model. Thus, the MMED operates under the assumption that a predetermined user interest in a visualization is related to their predetermined innate interest in experiencing flow and “being in the zone.”

At the risk of making an over generalization, the MMED also operates under a correlate assumption regarding human nature. Due to the time dependencies and dynamics of human experience, a necessary component and element of flow is synchronized activity. In other words, the energy and effort invested needs to directly contribute to the desired outcome, versus simply dissipating or even possibly negatively influencing the desired outcome. With this in mind, proper timing and synchronization is a critical dependent variable. Thus, the necessary rhythms and tempos associated with flow and “being in the zone” are considered critical components and introduce the awareness of timing, time scales, time horizons.

An analogy from physics helps further illustrate the relationship between flow and time dependent dynamics. Using a simple example of pushing a swing, each push must be properly timed to properly contribute to the goal of continuing to swing back and forth, as desired by all stakeholders. Without proper execution, the desired end result cannot be achieved. With ideal timing, the contribution of the energy and effort is maximized. Alternatively, if the timing is out of phase, the contribution will negatively contribute and defeat the desired goal by stopping the swinging motion.

Another common example is the similar rhythmic motion of physically rubbing the rim of a glass. The rhythmic cycle causes the rim of the glass to oscillate and move back-and-forth. The energy from the fingers is transferred into the glass and the frequency of relatively small displacements within the glass is determined by the composition of the glass. Thus, the ringing of the glass occurs at the natural frequency (aka resonant frequency) of the specific glass. Analogously, the MMED assumes that each individual person perceives an analogous “natural frequency,” also called a resonance, in relation to the elements of their human experience. In music, this type of sensation contributes to what is called consonance and dissonance. Thus, intrinsic to a person's composition is the fact that some thoughts, emotions, and activities engender and are consistent with a sense of resonance and consonance. This sense of resonance is considered a necessary and dependent variable for experiencing flow.

Creative visualization is another critical element of the MMED. Creative visualization (sports visualization) refers to the practice of seeking to affect the outer world via changing one's thoughts. In other words, “creative visualization is the technique of using one's imagination to visualize specific behaviors or events occurring in one's life. Advocates suggest creating a detailed schema of what one desires and then visualizing it over and over again with all of the senses (i.e., what do you see? what do you feel? what do you hear? what does it smell like?).” (http://en.wikipedia.org/wiki/Creative_visualization).

When the end-user envisions the actual dynamics of how predetermined and subsequently evoked visualizations, mental imagery, and other artifacts of mental modeling might influence their experience and sense of flow (aka “being in the zone”), this elicits and engenders yet another cascade of visualizations, mental images, emotions, and related sensations (e.g. consonance/dissonance). Note that there are an open number of other goals that to some extent or another are related to the overall creative visualization that relates to experiencing a sense of flow in relation to the given predetermined visualization(s) of mental models. As with the other phases of the elicitation process, the focus of activity is descriptive awareness (e.g. meta-cognitive observation, active listening).

Within the context of creative visualization, this means that the user simply envisions how an initial focus of attention on a visualization of a mental model may better contribute to and influence their sense of flow. In other words, the end user simply assesses how the objects of their attention can better contribute to the innate goal of optimized performance through well managed balances between “skill level” and “challenge level,” noting the importance of their innate resonance with the object of their attention and associated entities (e.g. visualizations, mental images, models, emotions, etc.).

A construct in the context of the present invention is an explicit accounting and description relating to a end-user's thought orientation, as well as, the end-user's one or more “trains of thought” or subvocalizations relative to end-user goals (e.g. experiencing “flow,” “being in the zone”) and the degree of resonance (e.g. consonance/dissonance). The accounting includes a scoring of the visual, verbal, and possibly other elements of one or more aggregated and inter-related visualizations, associated mental images, emotions, sensations, or goals/objectives. This is a descriptive exercise that simply produces an explicit representation that supports the construction (e.g. synthesis) of new mental models. Note that the process of producing a construct will elicit additional mental entities (e.g. images, emotions, feelings/sensations). These too are recorded with scorings of applicability. The construct pulls together the visual and verbal imagery and associated knowledge artifacts that provide an elaboration that is based or rooted in the context of one or more visualizations that are the primary focus of attention.

Ideally, if the visualization was initially of interest to the end-user, the construct should provide an explicit association with other associated knowledge artifacts that have either a positive or negative contribution toward user goals (e.g. experiencing flow relative to the degree of resonance with the given focus of attention). Thus, constructs flesh out the interrelatedness of knowledge artifacts (e.g. concepts, mental images, emotions, visualizations, sensations, verbal tags, goals/objectives) associated with how mental modeling influences and contributes toward an individual's performance and associated activities. To achieve flow and “being in the zone,” the elements of constructs help develop an awareness of positive and negative influences. In other words, constructs reveal thoughts, emotions, and autonomic elements that guide and influence a person's behavior, relative to one or more goals (e.g. flow, awareness of elements that influence the experience of flow).

As stated earlier, a mental model is an explanation of someone's thought process about how something works in the real world. It is a representation of the surrounding world, the relationships between its various parts and a person's intuitive perception about their own acts and their consequences (http://en.wikipedia.org/wiki/Mental_model). Additionally, mental models can also include cognitive constructs that help shape behavior and define possible approaches to solving problems (akin to a personal algorithm) and carrying out tasks.

Thus, improved and new mental models are captured in the explanations of the observations recorded in a given construct, or aggregation of constructs, and associated knowledge artifacts. This includes explanations and dialog regarding creative visualizations that result from interacting with the MMED. These updated and new explanations engender predetermined, as well as new, objects of attention that include hypotheses and conjectures. Such collections of entities are analyzed and their relative priorities are updated.

Visualizations of the resulting mental model, or possible collection of models, are another product and resulting artifact from interacting with the MMED and executing the associated elicitation process. As discussed earlier, a number of tools and resources are readily available for supporting the construction of visual displays. The visual, verbal, and other artifacts produced by the MMED provide a novel collection of content that is directly grounded in a person's perceptual experience, within the context of working to improve a user's well-being and performance of activities.

Ad hoc techniques and tools that engender stream of consciousness, free association, free recall, brainstorming, mind mapping, and metaphor elicitation, are examples of other types of association processes that may also be utilized from within the MMED operating context. Note that the MMED provides an unprecedented opportunity to establish a grounding of the results in a manner such that the content is more readily associated with commonly accepted mental models that relate more consistently and coherently with immediate human experience (e.g. sensation, perception, cognition).

Finally, the MMED provides a number of interactive user interface elements for representing and understanding the preferences, opinions, and feelings of the end-user. These visual, verbal, and other types of interactive user interfaces help describe the thinking of the end-user by synthesizing their mental models into an overall conceptual space and context that is grounded in canonical commonly-accepted reference models. This engaging mode of interaction, and resulting knowledge artifacts, are considered significant end products produced by the interactive sessions with a MMED apparatus and process.

Thus, functions typically associated with mental activities (e.g. executive function, working memory) are improved, as demonstrated by the user's improved ability to discover, relate, synthesize, and utilize the knowledge captured in the wealth of knowledge artifacts that are continuing to grow at an ever increasing exponential rate. Thus, the cumulative descriptive results from the MMED provide a critical resource for the separate, yet interdependent activity of creating more proactive knowledge artifacts (e.g. assessments, plans).

The method of manufacture of a MMED typically involves the following steps:

Step 1. Identify Core Set of Mental-Model Domains for a Overarching Domain of Interest

Step 2. Identify and Store Lists of Verbal Tags from Reference Resources (e.g. Wikipedia, USPTO, CareerOneSource, PubMed, Technical Papers/Publications)

Step 3. Identify and Store Schema Visualizations for Core Set of Mental-Model Domains

Step 4. Select Representative Schema Visualizations as Canonical Baseline Set of Examples

Step 5. For Each Canonical Visualization, Identify Applicable Verbal Elements in Visual Image

Step 6. Per Set of Visualizations, Map List of Verbal Elements to Applicable Knowledge Resources (e.g. Wikipedia, USPTO, CareerOneSource, PubMed, Technical Papers/Publications)

Step 7. Generate New Nodes in MMED Semantic Network for New Verbal Elements

Step 8. Identify Generic Value to Users and Map to Centralized Knowledgebase

Step 9. Identify Types of Knowledge Artifacts for Which Respective Mental Models Apply

Step 10. Generate Templates for Resulting Output Artifacts that Utilize Respective Mental Models

Step 11. If in Federated Mode, Synchronize New Instance with Other MMED Installations

Step 12. Where Applicable, Execute Proactive Search Capabilities and Related Algorithms to Prefetch and Assess Related Knowledge Resources and Artifacts

Step 13. Integrate Results of Previous Step (Step 12) with Initial Configuration

Step 14. Iterate Previous Steps as Needed to Establish Initial Release of MMED Configuration

An example embodiment of the MMED methodology, typically involves the following steps:

Step 1. Pedagogical Orientation with Initial Mental-Model Elicitation.

The MMED interactively interfaces with the end-user to ensure that the prerequisite knowledge and references models are sufficient for entering into a MMED session. The methodology focuses on eliciting user agreement regarding the visual and verbal information, as presented and described. A series of model elicitation sessions progressively establish a foundation of reference models that provide the basis for more specific and specialized mental modeling activities.

An initial introduction establishes an initial degree of familiarity with the foundational concepts and models. The previously discussed mental model visualizations, figures presented in this disclosure for example, introduce the user to the basic perspective and operative structure of the elicitation process.

Example orientation and mental model elicitation sessions provide additional information and technical details regarding the foundational reference models integral to the MMED apparatus and process. Within a given embodiment of the MMED, web-based on-line interactive learning modules and a wealth of additional educational materials are typically provided. Pedagogical modules, such as those listed below, tend to follow the same basic format and provide similar foundational understanding of available mental models as described by their respective visualizations and supporting material.

The following inter-related domains comprise an example baseline of MMED mental-modeling domains and their inter-relatedness in terms of improving individual performance and well-being:

1) Semiotic blending

2) Emotions

3) Phenomenology and semiotics (e.g. blends of mental models)

4) Genomics, genetics, endophenotypes, and physiology

5) Brain science (e.g. human brains, neurocognition, cognitive function, executive function, working memory)

6) Behavioral neuroscience (e.g. neurophenomenology, neuropsychology, neurocognition, neuropsychiatry, evolutionary psychology, genomic predispositions)

7) Intelligent systems (e.g. embodied cognitive science, artificial intelligence, robotics and automation)

8) Systems Engineering (e.g. model-driven Architecture, model-driven-engineering)

9) Organizational theory (e.g. ecosystems, enterprise architecture, business process modeling, competency-based management)

10) Human development psychology (e.g. social networks, developmental psychology, life span development and management)

11) Personal genomics, family genetics, personal history, family history, genealogy

12) Sports psychology (e.g. agility, mental toughness)

13) Values, interests, goals, objectives, plans, milestones, schedules, daily activities

14) Education, vocations, occupations, industries, patents, knowledge, skills, abilities, user assessments

Step 2. Mental-Model Elicitation for Domains of Interest.

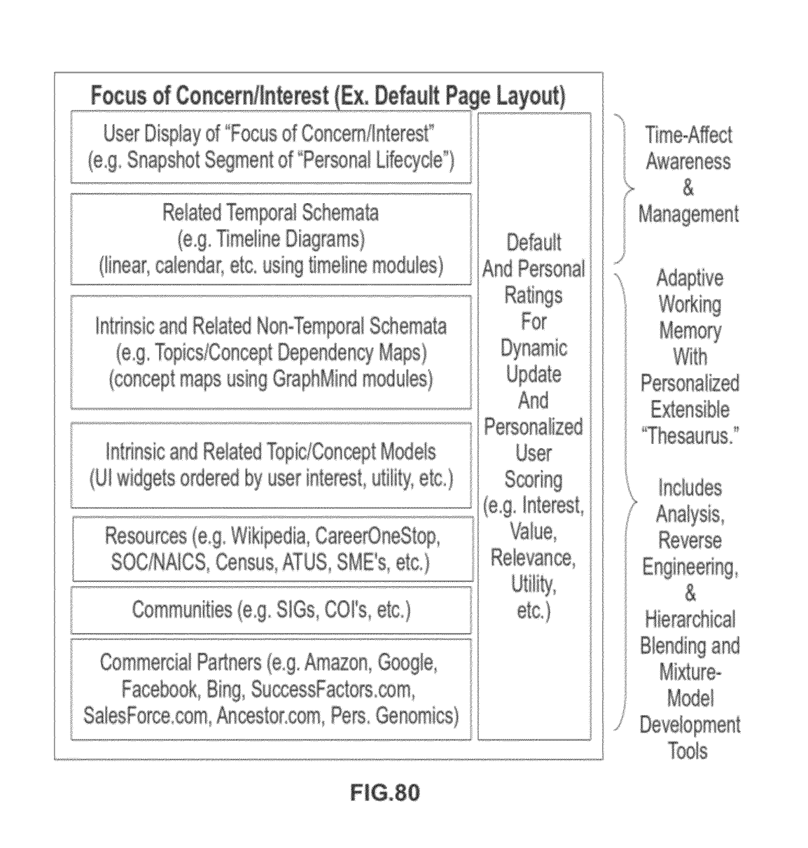

For the MMED, the default most generic type of user artifacts are called “Domains of Interest.” For each domain, there are one or more areas of interest that motivate the creation of “Focus of Interest/Concern” user models. FIG. 80 is an example default web page layout (aka view) for visualizing this type of artifact. This step provides the user with an interactive elicitation procedure that emphasizes information foraging and discovery functionality. This exploratory elicitation process leverages the baseline knowledgebase used for orientation, as well as, the results from the user interaction during the orientation process of step one.

Step 3. Production of Knowledge Artifacts of Interest.

Through interaction with the MMED, the user selects a variety of types of knowledge artifacts to be produced using the MMED. The content for these more application specific artifacts is derived from results of both of the above steps and the activities supported within this more deliverable oriented step.

Within this step of the process, the MMED includes procedures and algorithms for assessing the level of awareness and familiarity with the underlying mental models that enable the creation of the respective artifacts. If the assessment determines that the level of proficiency needs to be improved for a respective dependent mental model, the user is directed towards a more pedagogical type of interaction that may be more typical of the sessions associated with step one.

Examples of MMED assisted content transformations that assist and help automate production of the following specific “artifacts of interest,” comprising:

1) Personality and Psychometric Assessments (e.g. Holland Code, Briggs-Myers, Big Five, etc.)

2) Vocational/Occupational Interest Profile and Competency Map (e.g. CareerOneStop, NDSL)

3) Life Goals and Interests Assessment (e.g. Selection and scoring from generic taxonomies)

4) Time Usage Assessments (e.g. ATUS)

5) Mental Toughness Assessment and Development Plan (e.g. Sports Psychology Models)

6) Leadership Assessment and Development Plan (e.g. Scoring of leadership models)

7) Episodic Vignettes and Autobiographical Memories (e.g. developmental psychology phases)

8) Personal Genomics and Family History Assessment (e.g. NGS, genealogy, etc.)

9) Personal Health and Life Development Planning Roadmap

10) Provisional and Utility Patent Applications (e.g. USPTO)

11) Business Plans and Other Organizational Charters (e.g. IPT)

12) Project Portfolio Roadmaps and Associated Project Plans

13) Aggregated Visualizations of Verbal Elements of User-Created Mental Models

14) Picture books, graphic novels, comic books, and comic strips for sequencing elements of aggregated mental models and their representative mental imagery (e.g. visualizations)

15) Audio narratives (e.g. sequenced movie quotes that convey an aggregate message)

16) Mappings of Relatedness Between Mental-Model Elements (e.g. User-Generated Matrices)

17) Topic Interest Lexicon and Profile (e.g. Wikipedia Miner, Carrot2)

Example Embodiment of the MMED Apparatus

To effectuate the steps of the MMED process, an apparatus is provided whereby an end-user obtains the information and interaction needed to facilitate the necessary orientation and help create the resulting knowledge artifacts. The apparatus comprises a networked system that includes a repository of files of digital images and related knowledge artifacts from which are selected a series of images used for the orientation and artifact creation process. The user is able to add images and supporting information. The MMED also incorporates active algorithmic processes that proactively learn from the user interaction and can prefetch candidate related artifacts of interest. This is a functional element that helps automate and streamline the user workflow while also providing a quality control function that assesses MMED product status. Note that user profiling and psychometric assessment is an inherent MMED support element.

The scoring, sorting, and integration of the visualizations of mental models and supporting information is accomplished by a logic and data processing unit that works in conjunction with the operator interface unit via an electrical communications and networking subunit. During the orientation, as well as elicitation and exploratory information gathering phases of the knowledge artifact production process, an education and demonstration subunit may provide pedagogic support functions where needed.

For content management functionality and assisting with the creation of the knowledge artifacts, a content management system (CMS—e.g. Drupal, Joomla) may be configured with the necessary plug-in and application specific code to support the production process. In particular, templates are created for each of the types of artifacts to be produced. The functional relationships to predetermined and preconfigured mental models is incorporated and utilized to aid the user in the creation of the respective knowledge artifact. Existing resources that may be available are also identified and included in the configuration of the CMS templates and overarching MMED apparatus. Thus, where the user needs to fill in the respective sections of the given template, the MMED guides the user to potentially related resources and elicits an interaction that results in filling in the user specific content as needed. Note that the user can add new relationships and edit the baseline artifact format as desired.

Digital sound and webcam recordings are optional inputs for user-specific and archiving purposes. The apparatus of the present invention appends the digital recordings to the user specific repository. The (digital) voice recording contains what is technically called paralinguistic information. For example, paralinguistic elements include tone, inflection, and other cues or factors relating to how something is said. These factors convey important meaning beyond the actual words used and may even contradict those words. Paralinguistics is generally considered the study of the nonverbal dimension of communication. MMED algorithms may extract such information from the archived recordings to further augment the mental-model elicitation process. This type of nonverbal monitoring may also include physiology oriented monitoring (e.g heart rate, EEG, etc).

As previously discussed, the user is continuously scoring and inputting descriptions of personal mental activities, while interacting with the MMED (e.g. orientation and knowledge artifact production). These sensory oriented inputs (e.g. images) are stored digitally and represent an array of sounds, colors, shapes, and descriptions of smells, touches, etc. The customer is able to add descriptions to this cumulatively growing repository. These inputs are useful for exploring the precognitive/limbic, emotional, and more performance oriented (e.g. flow, zone) aspects of the MMED support functions. These inputs are utilized by the MMED to assist the mental-model elicitation and knowledge artifact production process.

Thus, steps 1, 2, and 3 identify some important constructs of users. Additional constructs are concurrently elicited using specific predetermined MMED-User interactive procedures. The sensory images, metaphors, and other information artifacts that the user has submitted or created while performing activities within steps 1, 2, and 3 are used as the basis for the stimuli for these proactive MMED interactions. The apparatus of the present invention contains these information elements and also the procedures for conducting the MMED-User interaction. In other words, this procedure involves a set of specifically designed thinking probes to help the user express feelings, thoughts, and values that provide additional elicitation of user mental models, relative to the reference models.

The user mental models associated or connected with each construct are the selected reference visualizations and sensory definitions of those constructs. They convey important verbal and nonverbal meanings of these constructs. Such meaningful information elements augment and complement verbal-only definitions. This is partially due to the fact that verbal skills of those whose input is being solicited vary widely. It has been found however that in employing visually interactive elicitation devices (i.e. tools), the verbal skills of a customer are not critical since the visual sensory development of persons is relatively more advanced than verbal development. Therefore, education level of a customer is not as critical to the MMED. Generally customers using the MMED are more equal on a sensory level than they are on a verbal skills level. This in turn also contributes to the orientation, learning, and knowledge discovery payoff for less educated users.

The MMED typically runs on the Linux family of computers as available for home/office use and provided by web-hosting services. However, the MMED can also be implemented on other compatible computer architectures that include networks of PC and mobile devices (e.g. smartPhones/Android, tablets, eBooks) that interact with the user through a variety of user interfaces and direct transducer interactions (e.g. GPS, cameras, microphones, physiology/EEG, and other sensors). Thus, low cost scanners, mobile devices, tablets, webcams, and microphones provide a baseline set of networked devices that comprise the MMED. Additional output devices include laser printers for providing hard-copy output of images created.

### DRAWINGS

### Figures

FIG. 10 (Prior Art) diagrammatic illustration of the Yerkes-Dodson Law (http://en.wikipedia.org/wiki/Yerkes-Dodson_Law). The diagram illustrates that the quality of performance is maximized if the level of a person's arousal is somewhere between a mental state of mild alertness and feeling stressed.

FIG. 20 (Prior Art) from Nakamura and Csikszentmihalyi 2009 (http://books.google.com/books?hl=en&lr=&id=6IyqCNBD6oIC&oi=fnd&pg=PA195&dq=Csikszentmihalyi+Finding+Flow&ots=IJJdMIW9uC&sig=f1O6aelbCGOcWOc7GRStuRGnEZ4#v=onepage&q=Csikszentmihalyi%20Finding%20Flow&f=false) another example visualization that illustrates how this maximized quality of performance is a “zone” between anxiety and boredom, whereby there is a balance between “action opportunities (challenges)” and “action capabilities (skills).”

FIG. 30 (Prior Art) from Csikszentmihalyi 1988 (http://en.wikipedia.org/wiki/Flow_%28psychology%29), is another schematic diagram that illustrates the fundamental tradeoffs between skill-levels and challenge-levels. Note that the various regions correspond to the emotional state of an individual when addressing the respective combination of skill levels (i.e. capabilities) and challenges (i.e. task demands). Note that the optimal state is typically “flow.”

FIG. 40 (Prior Art) from Fuller 2005 (http://p2sl.berkeley.edu/2009-09-09/Fuller%202005%20Towards%20a%20General%20Theory%20of%20Driver%20Behaviour%20%3D%20TheoryofDrivingBehavior.pdf), is a schematic diagram that illustrates how satisfaction of task demands depend on a hierarchy of underlying capabilities and associated subelements (human factors, competence, training, education, experience, and constitutional features). Control is maintained when capabilities exceed the task demands. Alternatively, there is a loss of control when task demands exceed capabilities.

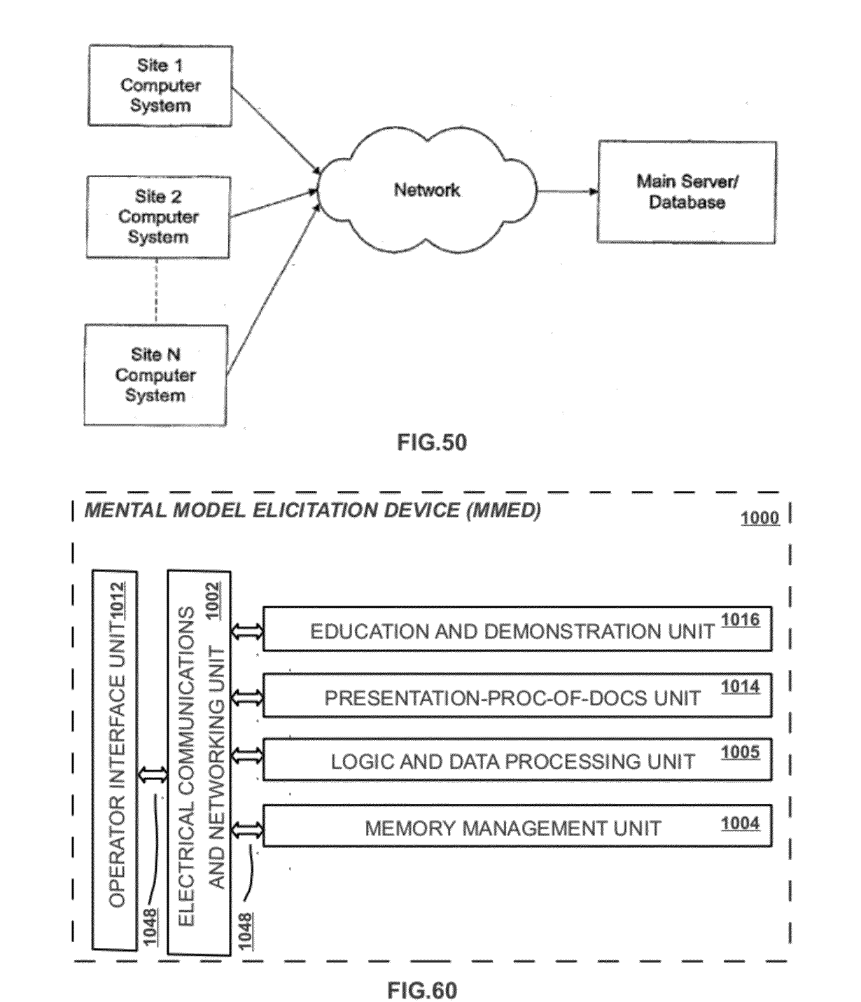

FIG. 50 Diagram of example MMED apparatus, highlighting the networking of individual elements.

FIG. 60 Functional block diagram of an example MMED apparatus with a minimal set of necessary functional elements.

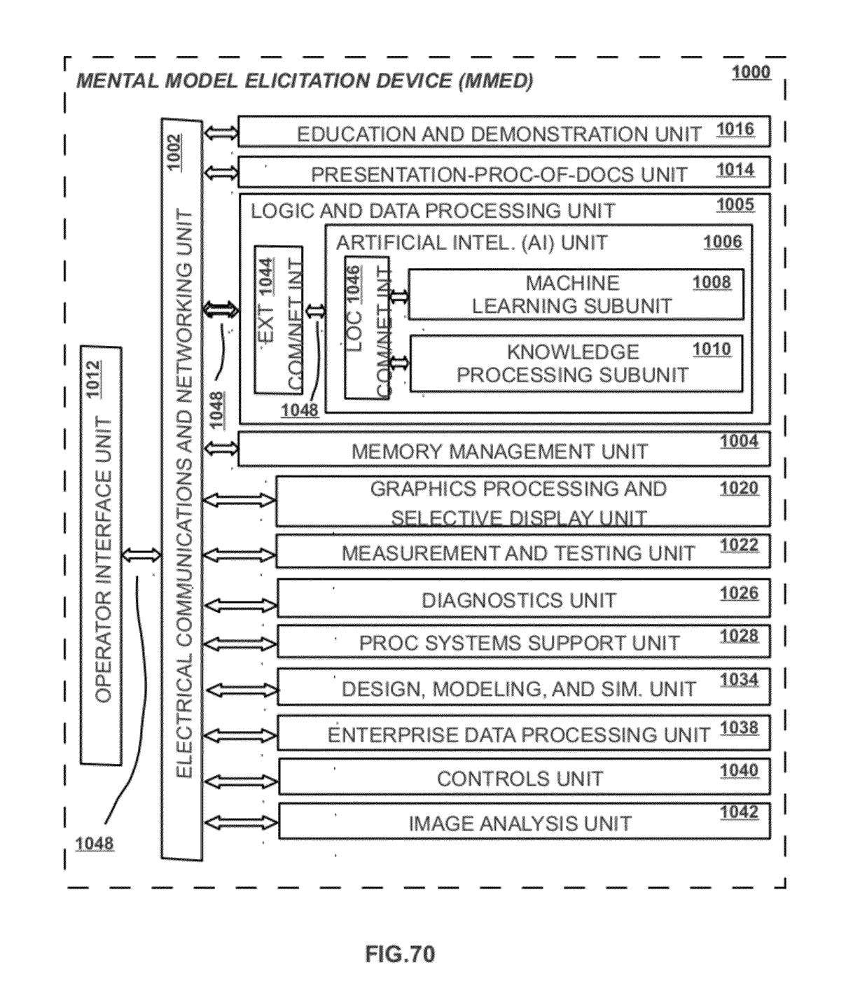

FIG. 70 Functional block diagram of an example MMED apparatus with additional functional elements as may typically be needed for various applications.

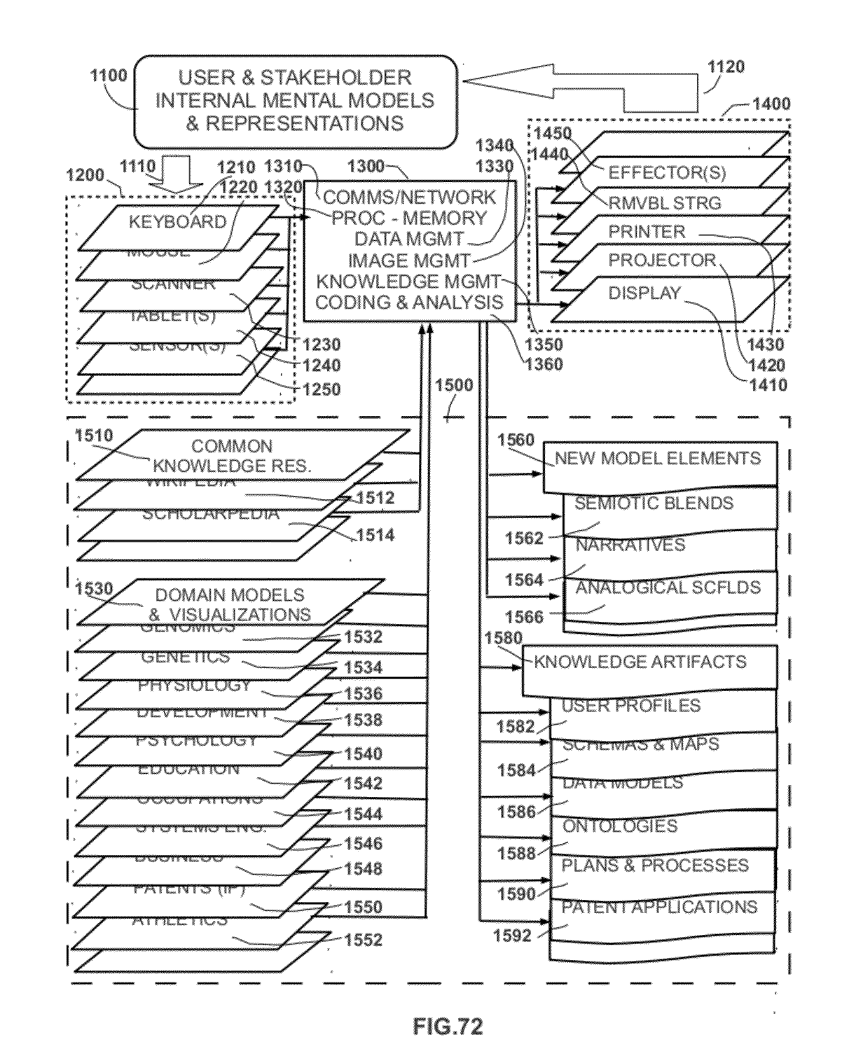

FIG. 72 MMED system architecture. Note that the elements do not necessary comply with the USPTO patent classification system.

FIG. 80 From an example MMED embodiment, a user interface display diagram that focuses on a particular user's specific topic or area of concern. The “focus of concern” is by default a snapshot segment of some aspect of the user's “personal lifecycle.” From initial registration and throughout the lifetime of the user's membership to the service that provides this embodiment of this tool, the user and associated user-interface elements are always oriented towards the interests, events, activities, and roles that are explicitly associated with the user's own individual lifecycle. At the top of the example page, subelements (e.g. windows, panels, widgets, etc.) help maintain an awareness and explicit relationship of the topics/concepts and subtopics/subconcepts to the user's individual interests, values, goals, and associated entities. Thus, the backend services (CMS, Wiki, LMS, Web Resources, etc.) provide an adaptive and extensible “working memory” that is augmented with a number of extensible and adaptive tools (e.g. thesaurus, analysis and reverse-engineering). Typically, all display elements have meta-processes and meta-data displays that allow the user to continuously update the utility and relevance of the topics/concepts and associated display items. within each sub-domain a multiplicity of sub-domains and links are user-configurable.

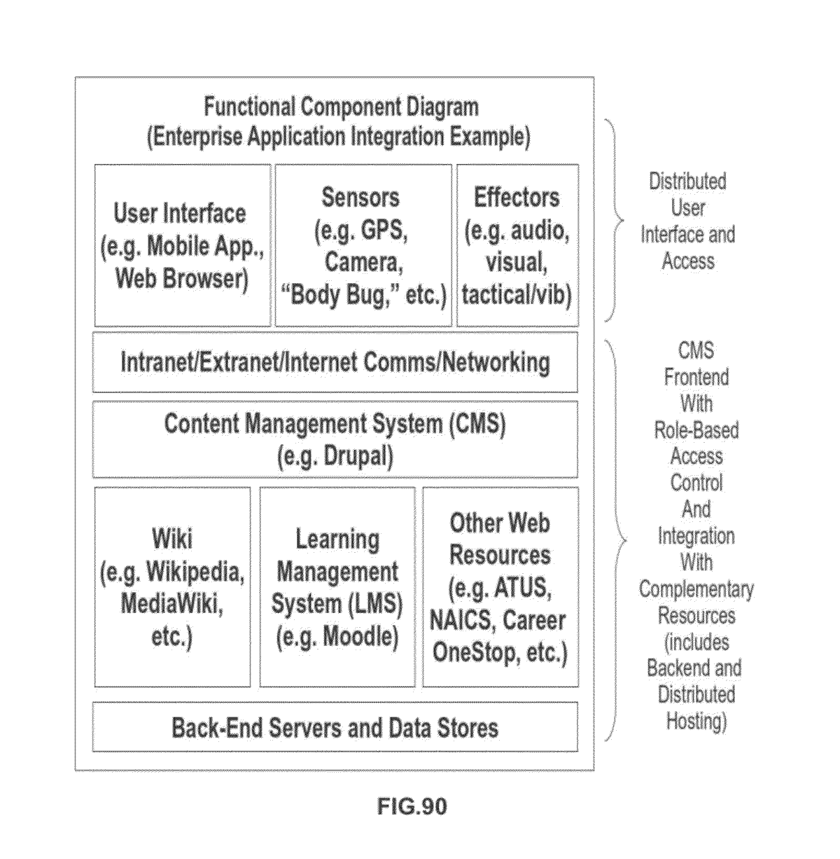

FIG. 90 From an example MMED embodiment, an example functional component diagram for MMED apparatus configured using an integrated assembly of FOSS enterprise applications (e.g. Drupal, mediaWiki, Moodle, etc.). Note that the interface elements include mobile, desktop, and direct sensor (e.g. camera, GPS, BodyBugg) and effector interfaces (e.g. audio, visual, tactical/vibration). The backend server-side components are the FOSS application and related software (CMS, Wiki, LMS, web resources, internal servers and databases).

### DRAWINGS

### Reference Numerals

1000 mental model elicitation device
1002 electrical communications unit
1004 memory management unit
1005 logic and data processing unit
1006 artificial intelligence (AI) data processing unit
1008 machine learning subunit
1010 knowledge processing subunit
1012 operator interface unit
1014 presentation processing of documents unit
1016 education and demonstration unit
1020 graphics processing and selective display unit
1022 measurement and testing unit
1026 diagnostics unit
1028 processing systems support unit
1034 design, modeling, and simulation unit
1038 enterprise data processing unit
1040 controls unit
1042 image analysis unit
1044 unit communications and networking interface
1046 localized/internal subunit communications and networking interface
1048 transactional activity between units, typically interactive informational exchanges
1100 user & stakeholder internal mental models & representations
1110 dataflow from MMED users to MMED input devices
1120 dataflow from MMED output devices to MMED users
1200 MMED input devices
1210 keyboard
1220 mouse
1230 scanner
1240 tablet(s)
1250 sensor(s)
1300 MMED logically centralized processing unit
1310 communications and networking subunit
1320 processing and memory subunit
1330 data management subunit
1340 image management subunit
1350 knowledge management subunit
1360 coding and analysis subunit
1400 MMED output devices
1410 display
1420 projector
1430 printer
1440 removable storage
1450 effectors(s)
1500 MMED knowledgebase management system
1510 common-knowledge resources
1512 Wikipedia
1514 Scholarpedia
1530 domain models and visualizations
1532 genomics
1534 genetics
1536 physiology
1538 development
1540 psychology
1542 education
1544 occupations
1546 systems engineering
1548 business
1550 patents and intellectual property rights (IP)
1552 athletics
1560 MMED-specific model elements
1562 semiotic blends
1564 narratives
1566 analogical scaffolds
1580 MMED-specific knowledge artifacts
1582 user profiles
1584 schemas and associated conceptual mappings
1586 data models
1588 ontologies
1590 plans and process-oriented content
1592 patent applications

### DETAILED DESCRIPTION

### FIG. 50 to FIG. 90

### Example Embodiment

To the extent possible, the following paragraphs describe and teach in the terms and definitions of the United States patent classification system. For purposes of this description and teaching of the patent, the figures and diagrams illustrate logically defined views that demonstrate the logical segmentation into the respective aggregation, assemblage, or ensemble of the respective elements and subelements. Thus, the apparatus includes physically modularized devices, or possibly includes embodiments that transform the logically specified devices into a monolithic solution that physically intermingles, distributes, or rearranges the functionally defined elements and subelements as required for a specific physical embodiment. Given this potential mapping of a logically specified device, an embodiment of an element or subelement is nonetheless a physical device, or a physically distributed process within a mixture of other devices. As stated, and for purposes of this description, the terms “device,” “element,” “subelement,” “unit,” and “subunit,” are considered to logically describe and specify an apparatus whereby a particular physical embodiment is a potentially distributed instance of the type of device described.

FIG. 60 provides a block diagram view of the minimum number of fundamental elements considered necessary an embodiment of a MMED apparatus (1000). This assemblage comprises the following required elements and subelements: (a) an electrical communications element (1002) for the handling of information or intelligence which is handled by signaling systems or signaling devices or by that portion of nonsignaling systems or nonsignaling devices which is designated in the arts as having a control function; (b) a memory management element (1004) for information storage and retrieval; (c) a logic unit for measuring, discovering, and managing associations between said storage and retrieval information elements; (d) an operator interface data processing element (1012) for implementing user interaction with a computer system wherein such interaction is used as a means for controlling the presentation of display data, for processing of interactive data for presentation, or implementing windowing techniques that can include interactive processes; (e) a presentation processing of document data processing element (1014) for gathering, associating, creating, formatting, editing, preparing, or otherwise processing data elements to be presented, or wherein the relationship between such elements in a document or portion thereof is defined; (f) an education and demonstration element (1016) for providing instruction about a subject, process, or procedures; testing or grading a person's knowledge, skill, discipline, or mental or physical ability; displaying for purpose of comparison contrast, or demonstration; demonstrating characteristics and advantages of apparatus, objects, or processes; (g) wherein said communications element (1002) provides for exchanging information and connects said memory management element (1004), operator interface data processing element (1012), said presentation processing of document data processing element (1014), and said education and demonstration element (1016);

FIG. 70 provides a block diagram view of example elements of a MMED apparatus configured for further enhancing analysis and modeling functionality. This example assemblage comprises the elements necessary for a minimal embodiment (FIG. 60) plus the following example elements and subelements: (a) graphics processing and selective display (1020); (b) measurement and testing element (1022); (c) diagnostics element (1026); (d) processing systems support element (1028); (e) design, modeling, and simulation element (1034); (f) enterprise data processing element (1038); (g) controls element (1040); (h) image analysis element (1042).

SYSTEM ARCHITECTURE: Referring to FIG. 72 the MMED system architecture is further described. In terms of the system architecture, the apparatus comprises a display (1410) for displaying alpha numeric data as well as the various representations viewed by a customer. The apparatus further comprises a keyboard (1210), a mouse (1220), scanner (1230), one or more touch screen digital tablets, which include mobile wireless devices and phones (1240), and one or more sensors (1250) for reading sensor information directly into the logically centralized MMED processing unit (1300).

In this example embodiment, the logically centralized processing unit (1300) further comprises a communications and networking subunit (1310), processing and memory subunits (1320), data management subunit (1330), image management subunit (1340), knowledge management subunit (1350), and coding and analysis subunit (1350) for inputting data and designating memory model representations or elements of such representations which are to be used to interact with the users and stakeholders (1100) and with the MMED knowledgebase, as highlighted by the dashed line in the lower half of the FIG. 1500-coarsely dashed line).

The larger arrows (1110 and 1120) indicate the data and information flow from the MMED users and associated stakeholders (1100) through the physically instantiated MMED input devices (1200) and then to the MMED logically centralized processing unit (1300). The input devices are highlighted within the ultra-fine dashed line on the left side of the drawing, The processing unit (1300) further interacts with the MMED knowledgebase (1500) and interacts with the physically instantiated MMED output devices (1400). The MMED output devices (1400) are highlighted within the ultra-fine dashed line on the right hand side of the diagram.

The centralized processing unit (1300) comprises various logic whereby input commands can be received from the input devices (1200). The MMED processing comprises data, image and knowledge processing/management software for managing the associations of elements of the visual representations as well as to allow the input of alpha numeric data. The processor also comprises knowledge and data management software allowing dynamically generated visualizations to be modified, created, displayed and stored. It also comprises animation and gaming software for computer assisted creation of animated narratives. The processor also contains software for coding and analyzing mental constructs, sensory stimuli, narratives, and certain aspects of users' verbal language digitally recorded or entered as text. The processor contains additional software that creates tables, graphs, consensus maps, and other analyses unique to MMED sessions and required for interactively reporting and monitoring results. The processor also contains software which helps guide the users and stakeholders through the sequence of steps and through the activities within each step.

The MMED knowledgebase (1500), also called the MMED knowledge management system (MMED KBMS), comprises a number of common-knowledge resources (1510), domains specific resources and associated visual representations (1530), synthesized model elements specific to the MMED (1560), and other types of knowledge artifacts with variants specific to the MMED (1580).

The MMED common knowledge resources (1510) typically comprise globally-accessible openly reviewed resources such as Wikipedia (1512), Scholarpedia (1514), and other common knowledge resources. The MMED domain specific models and associated repositories of visual representations (1530), typically cover a broad range of disciplines and areas of study that may include genomics (1532), genetics (1534), physiology (1536), development (1538), psychology (1540), education (1542), occupations (1544), systems engineering (1546), business (1548), patents and intellectual property rights (1550), athletics (15652), and other applicable domains as needed for the intended applications, users, and stakeholders. Note that internal to the MMED KBMS, specialized software and encoded algorithms provide a rich set of transformations that preprocess, analyze, and mine MMED KBMS accessible information. Thus, the MMED KBMS works to optimize the MMED end-user and stakeholder experience, while maximizing the return on their investment in time, effort, and information exchanges.

In terms of the intellectual property and products produces, the MMED KBMS logically includes MMED specific modeling elements (1560) and knowledge artifacts (1580). As discussed earlier, the internal physical representations may be context dependence and dynamically determined. In any case, the logical equivalents of the MMED specific modeling elements will typically include semiotic blends (1562), narratives (1564), analogical scaffolds (1566), and other model elements as needed or opportunities provide. The MMED specific knowledge artifacts (1580) typically include session related content, such as user profiles (1582), schemas and related conceptual mappings (1584), data models (1586), ontologies (1588), plans and process-oriented content (1590), patent applications (1592), and other artifacts as needed or opportunities provide.

USER INTERFACE: FIG. 80 is a sampling of a user interface of the example embodiment whereby an individual is able to use mouse clicks, keystrokes, touches, or voice commands to discover topics and concepts within a predetermined structured context. Each of the topics and concepts are further associated with other concepts and topics that have predetermined and dynamically determined associations that may pertain to the individual user. The user is able to select and refine which potential associations apply to their specific context and objectives. The information gathered from each individual user is compiled into a statistical profile that allows the user to assess how their inputs and preferences compare against collections of other users. Additional interface elements support a separate family of interface displays that provide such statistical comparisons. Discovery of what other users select and their refinements regarding specific relationships, provides an indirect means for further discovering concepts and topics of interest that relate to predetermined and associated information elements. As highlighted by FIG. 80, the information elements (e.g. concepts and topics) can be ranked by prioritized categories, relative to an overarching concept or topic, such as personal interest, career goal, or other domain. Symbols and icons can be further associated with each category whereby the information elements of interest may be designated as “information berries,” “information nuggets,” or other pertinent labels.

FUNCTIONAL COMPONENTS: As highlighted in FIG. 90, freely available resources, such as Free Open Source Software and Content (FOSS/C), are being leveraged for implementing MMED embodiments. The role based access control (RBAC) and associated content management system (CMS) elements of this implementation are supported through the utilization of a FOSS/C CMS called Drupal (www.drupal.org). Extensions to the base configuration provide additional functionality for customer/client management (e.g. CiviCRM) and project/time management (e.g. Storm). The recording of individual user inputs and associated statistics and other support processing functionality is supported through available modules and extensions, as well as, additional software improvements as needed (e.g. new modules and PHP coding).

The Wikipedia application software, called mediaWiki is used for hosting specialized wiki configurations that support the storage and access of topics that may, or may not, be included within publicly accessible wikis, such as Wikipedia. For those topics which have Wikipedia entries, specialized configurations augment preexisting Wikipedia entries. To the extent feasible, such mental-model elicitation and information foraging embodiments may facilitate the creation and submission of new Wikipedia entries that result from an individual user's activities and use of this example embodiment. Thus, where possible, the applicable results of the foraging activity will more autonomously migrate to the more public and well established bibliographic resources, such as Wikipedia. Creation of personal wiki pages is facilitated by a private hosting and tailored configuration of tools such as mediaWiki.

The example Drupal and mediaWiki configurations directly support incremental extensibility such that this baseline configuration can be readily augmented to include publicly available discovery resources such as public databases (e.g. Career OneStop, ATUS, etc.), search engines (e.g. www.google.com, www.yahoo.com) and associated clustering of search results (e.g. www.carrot2.org). The example implementation incorporates the ability for the mental-model elicitation and information foraging activity to include user submission of user selected topics and concepts to the respective search and clustering resources, whereby the user is able to input the user specific categorization and degree of relationship for the respective search and follow-on processing (e.g. clustering). A topic scoring resource, such as Wikipedia Miner provides a means for explicitly assigning more objectively derived (e.g. algorithmic) degrees of relationship between topics and also supporting a more automated means for topic clustering.

User help, training, and education is further supported through the utilization of help functions within the respective FOSS/C resources (e.g. mediaWiki, Drupal). For this particular implementation, a Learning Management System (LMS) called Moodle, may be further utilized for supporting the development of training and education modules that assist with helping users to more rapidly improve their level of competency for their mental-model elicitation, information foraging, and associated analysis activities.

The artifacts produced by this implementation include user configurable mental-model elicitation and information foraging results that are mapped into more structured executive-function and working-memory constructs (e.g. taxonomies, hyper-linked thesaurus, relationship and association matrices, topic landscapes). These constructs are in turn readily output in a variety of file formats and web services as available within the suite of FOSS/C tools utilized or software functionality as desired. Thus, through the availability and use of this new type of elicitation apparatus, the human task of mental-model elicitation and information foraging is improved beyond the organic executive-function and working-memory of the human user to include a more focused interaction that produces individual lifecycle related artifacts.

EXAMPLE OPERATION: A user is able to browse the publicly accessible user interface (e.g. web pages). In this example, public functionality includes limited discovery and access to predetermined concepts, topics, visualizations, models, and a limited number of predetermined relationships and associations between such semantic constructs.

Once becoming a registered user, an extended number of predetermined constructs and associated relationships are made available to the registered user. As the user interacts with the apparatus through the user interface, the user inputs (e.g. categorization and scoring of topics and associated relationships) condition and drive the subsequent displays such that the user is able to further explore related concepts and topics. A metric of interest is the ability to facilitate an increased rate of discovery of valuable information elements (e.g. “information berries” and “information nuggets”) that the user subsequently scores as being of personal interest and value and noted for incorporation in the enhanced working-memory element. Thus, this new type of apparatus for elicitation of mental models includes the necessary functionality for gathering, generating, and assembling knowledge artifacts (e.g. models) and associated data from a range of respective domains and subdomains.

The apparatus facilitates the scoring of default associations and correlations with regard to applicability of respective knowledge artifacts and their model elements. The resulting correlation scores as provided are scored by the end-user to further identify applicability. Similarly, knowledge artifacts, which include association and correlation scores within each domain, are scored. Where possible, users enter new associations and correlations with estimated scores. User entries further contribute to the net value of the knowledge processing system. The net result is a mutual improvement in the performance of end-user testing, discovery, assessment, and diagnosis.

The information foraging subelement supports the recording and recalling of end-user scoring of discovered knowledge artifacts. The subelement further leverages models of collaborative tagging, and associated social tagging and collaborative tagging systems. Thus, the system assists in refining dependencies between knowledge artifacts and their elements within and across domains. Dependencies include associations, correlations, scores, and other related values.

METHOD OF MANUFACTURE OF APPARATUS: The method of construction of an apparatus for elicitation of mental models, is in addition to the embodiment and operational use of the device.

Most generally, a method of construction comprising the following activities: (1) providing an electrical communications subelement; (2) providing a dynamically extensible information storage and retrieval subelement; (3) gathering data models comprising of schema, schema elements, and related knowledge representation artifacts; (4) constructing association matrices that explicitly relate elements of said data models and associations of said elements with a plurality of other model domains; (5) constructing a working memory element comprising of said data models, schema, schema elements, topics, and respective associations thereof; (6) providing operator interface subelements.

As highlighted in the multiple embodiments, there are an open number of potential embodiments each with potentially an open number of ramifications. For example, the results of the above methods of construction can range from manually generated and managed artifacts that are restricted to ink and paper embodiments of knowledge artifacts (e.g. records, files, filing cabinets, papers, books, standard operating procedures, job aids). Thus, computing machinery is not an absolute necessity in regards to the method of constructing the apparatus. The non-automated configuration and assemblage of elements includes more intensive manual human activities for communications, data management, and processing, as well as other activities that are not automated using electronic communications and data processing technologies.

Due to the availability of FOSS/C and a globally interconnected infrastructure (e.g. Internet and wireless mobile communications), the typical resulting artifacts are highly reconfigurable configurations and assemblages of elements that are logically and visually represented. As discussed earlier, current technology supports a multiplicity of options for mapping and binding of the functionality to best meet the needs and desires of an individual context and use-case. The following paragraphs outline contrasting resulting artifacts based on the respective context of an existing (1) SOA framework, (2) configurable predetermined enterprise applications (e.g. blog, wiki, CMS, LMS), or (3) specialized application-specific custom configuration.

For a services oriented configuration and assemblage, as common for SOA frameworks, one may tend to generate a physical embodiment of each logical element producing a more literal one-to-one mapping of the elements as drawn within the diagrams of the figures. A limiting factor for this segregation of various concentrated focuses of concerns (e.g. services corresponding most directly to logical functionality), may be the similar sub-functions within these services elements that are cross-cutting aspects, such as functions that “get” and “put” data items within the internal stores of the services, or for example, perform various information logging functions. There are currently a number of commercially available SOA frameworks with associated engineering methodologies that can be employed to produce the final embodiment for the apparatus, using the above method description. Note that depending on the SOA framework and associated engineering methodology, an open number of physical embodiments are potentially possible. A potential advantage of a SOA framework implementation includes the potential reuse or outsourcing of existing SOA services.

Separate from the use of SOA frameworks for implementing the apparatus, a more ad hoc collection of configurable enterprise application software tools and resources (e.g. wordpress, mediawiki, drupal, moodle) can be utilized to generate a final apparatus that is a configurable assemblage of elements that collectively implement the logical functionality but not necessarily in as much of a logically distinctive manner as a SOA framework oriented implementation. Thus, the more collaborative journal and more spontaneous dialog related elements may be primarily in a configurable blogging tool (e.g. Wordpress) while still also available and potentially implemented within the extensible wiki (e.g. mediaWiki), content management system (CMS—e.g. Drupal), or learning management system (LMS—Moodle) resources.

Finally, resulting physical implementations can be a highly automated and custom assemblages of system-of-systems that are each highly specialized and customized physical elements that may (or may not) operate in highly autonomously or interdependent modes. This includes customized assemblages of devices each with a system on a chip and associated physical subelements (e.g. sensors, actuators, communications devices). At this time, this type of application specific construction is widely considered economically prohibitive and not the most price or time-to-market competitive approach. Nonetheless, the method of building the apparatus, as disclosed above, can be utilized to produce this type of apparatus for eliciting mental models. Note that this generative type of application-specific process parallels much of the type of approach used for application specific integrated circuit, silicon compiler, reconfigurable computing, and feature oriented programming technologies. Thus, within the near future there may be technological innovations that support competitive marketable embodiments that create individualized monolithic physical implementations that distribute the logical functionally potentially throughout the resulting monolithic physical embodiment. This type of resulting implementation may in principle, be easier to reimplement and reconfigure as desired and needed by the enduser or dictated by market dynamics.

### ADVANTAGES

From the description above, a number of advantages become evident for the herein defined methods and apparatus for mental-model elicitation, as disclosed:

(1) helps individuals enhance their cognitive performance, whereby they are better able to address an emerging “literacy gap” associated with the rapidly expanding capability to create new knowledge and associated artifacts.

(2) helps individuals become more aware of how these emerging unprecedented developments in the creation and expansion of knowledge can help further improve their lives and, in particular, their livelihood and physical well-being.

(3) provides a means of enhancing the ability of humans to perform tasks that comprise a variety of cognitive elements that include executive-function and working-memory.

(4) provides a means for individuals and respective collections of individuals to more knowingly and skillfully perform tasks that comprise cognitive elements (e.g. executive-function and working-memory).

(5) enables individuals to further discover, record, and manage specific dependencies that span the full spectrum of knowledge that directly applies to enhancing an individual's performance of tasks. This facilitates a systems lifecycle management type of approach as is more common in an enterprise oriented context. Thus, a more extensive and explicit lifecycle management can be applied at the individual level, for creating a more individualized system or systematic management process.

(6) enables emerging knowledge of personal genomics, neuroscience, and cognitive sciences to be explicitly associated with EA/SOA within a new and nonobvious assemblage of mental models that help individuals better discover and manage emerging interdependent knowledge with respect to their individual quality of life and associated lifestyle.

(7) addresses and aids functional classes of neurocognition, such as executive function and working memory, by defining and managing an individual's neurocognitive self-assessment within the context of the larger context of the utilization of such cognitive capacities. In particular, the value of the device and methods can be explicitly tied to the value of such cognitive functions, relative to the workflow and associated activities of the given individual.

(8) assists and augments executive-function and working-memory capabilities of individuals as a means for further improving and enhancing their task performance capabilities.

(9) incorporates and improves upon existing tools that provide a means for better utilizing and improving upon currently available knowledge discovery, assessment, and management tools and related resources.

(10) helps individuals with more explicit and better directed discovery and management of their predispositions, inherent constraints, interests, values, goals, objectives, plans, and explicitly associated tasks.

(11) enables individuals to make more explicit and in depth connections to new knowledge that is only recently available for better enhancing human task performance through discovery, assessment, management, and planning of individual lives within an explicit lifecycle management context based upon emerging EA technology.

(12) provides for employing enhanced executive function and working-memory functions to better assess one's own genetic predispositions, physiology, neuroscience, psychology, life and family history, and culture.

(13) provides an improved executive function and working memory more directed to improved assessment capabilities. This enhanced functionality improves and transforms an individual's ability to discover their own interests, values, goals, and objectives with respect to their vocational, occupational, and career options. Thus, improving their own lifecycle management capabilities.

(14) enables an individual to more explicitly build and construct specific subelements of executive function and working memory (e.g. neurocognitive models; knowledge bases; associative memory subelements; task planning and monitoring subelements; organizational timekeeping and time management subelements; visualization and operations management subelements) that are much improved from the otherwise more manually and organically derived correlates.

(15) provides for transforming the lifestyle and daily activities of individuals such that the discovery and achievement of their own potential goals and objectives are enhanced and realized to the greatest extent possible.

(16) provides a basis for collections of individuals to better organize and more explicitly manage the represented individuals within a more comprehensive and win-win context.

(17) provides a more explicitly defined, cross-referenced, and comprehensive assemblage of concepts that directly result from operator interaction with the new type of device. For example, genomics and psychometric knowledge is explicitly associated with an individual's interests, values, goals, and further associated objectives and milestones.

(18) enables creation of interconnection matrices that explicitly represent estimates of relatedness across otherwise more separate models and schema. Thus, explicitly represented and managed user specific connections are furthermore incorporated into self-assessment and life planning.

(19) enables individuals to create knowledge artifacts more traditionally associated with business process management and enterprise computing (e.g. mission statements, charters, enterprise architecture models, business plans, patent applications, partnership agreements).

(20) improves upon the executive function and working memory subelements that are critical to the literacy, fitness, self-assessment, well being, and competitive success of individuals and their collective organization.

(21) enables an individual to discover topics and concepts within a predetermined structured context. Each of the topics and concepts are further associated with other concepts and topics that have predetermined and dynamically determined associations that may pertain to the individual user.

(22) enables an individual to select and refine which potential associations apply. The information gathered from each individual user is compiled into a statistical profile that allows the user to assess how their inputs and preferences compare against collections of other users.

(23) provides ability for the information elements (e.g. concepts and topics) to be ranked by prioritized categories, relative to an overarching concept or topic, such as personal interest, career goal, or other domain.

(24) enables more recognizable icons for ranking associations of categories whereby the information elements of interest may be designated as “information berries,” “information nuggets,” or other pertinent labels.

(25) facilitates the creation and submission of new Wikipedia entries that result from an individual user's mental-model elicitation and information foraging activities.

(26) supports incremental extensibility such that this baseline configuration can be readily augmented to include publicly available discovery resources such as search engines (e.g. www.google.com, www.yahoo.com) and associated clustering of search results (e.g. www.carrot2.org).

(27) includes user submission of user selected topics and concepts to search and clustering resources, whereby the user is able to input the user specific categorization and degree of relationship for the respective search and follow-on processing (e.g. clustering).

(28) user inputs (e.g. categorization and scoring of topics and associated relationships) condition and drive the subsequent displays such that the user is able to further explore related concepts and topics.

(29) facilitates an increased rate of discovery of valuable information elements (e.g.

“information berries” and “information nuggets”) that the user subsequently scores as being of personal interest and value.

(30) provides for gathering, generating, and assembling knowledge artifacts (e.g. models) and associated data that includes population samples and personal data from a range of respective domains and subdomains that include but are not limited to the following: (a) interests, values, goals, and objectives; (b) vocations, occupations; (c) executive skills, enterprise literacy; (d) education, training; (e) fitness, athletics; (f) wellness, health, nutrition; (g) neuroscience, psychology; (h) development, physiology; (i) genealogy and family history; (j) personal genomics, genetics, proteomics, and phenomics.

(31) facilitates the scoring of default associations and correlations with regard to personal applicability of respective knowledge artifacts and their model elements.

(32) enables generation of an end-user database that includes prioritized lists of interests, values, goals, and objectives. These results are interactively analyzed to produce one or more plans that include milestone schedules for the goals and objectives that are listed.

(33) assists in refining dependencies between knowledge artifacts and their elements within and across domains. Dependencies include associations, correlations, scores, and other related values. Sequencing and time dependencies are utilized to produce aligned milestone schedules.

(34) helps and guides a user towards the construction and refinement of their own personal lifecycle whereby they are able to discover and flesh out a broad assortment of topics and concepts related to their own personalized individual development and associated lifetime planning.

(35) enables a user to become aware and familiar with what is typically a more enterprise and human resources oriented notion of an individual development plan (IDP). This is an educational and literacy oriented benefit that is of value for helping a person in terms of being better prepared for an enterprise computing oriented work environment.

(36) enables an individual to better assess, analyze, and plan their development from a much broader and more in depth perspective.

(37) enables a user to more easily, quickly, and automatically produce a wide variety of knowledge artifacts, such as individualized knowledge bases, individualized topic maps and tag spaces, individual development plans (IDP), patent applications, and business plans.

### SUMMARY

A mental-model elicitation process and apparatus, called the Mental-Model Elicitation Device (MMED) is described. The MMED is used to give rise to more effective end-user mental-modeling activities that require executive function and working memory functionality. The method and apparatus is visual analysis based, allowing visual and other sensory representations to be given to thoughts, attitudes, and interpretations of a user about a given visualization of a mental-model, or aggregations of such visualizations and their respective blending. Other configurations of the apparatus and steps of the process may be created without departing from the spirit of the invention as disclosed.

### RAMIFICATION AND SCOPE

While the above description contains many specificities, these should not be construed as limitations on the scope of any embodiment, but as exemplifications of various embodiments thereof. Many other ramifications and variations are possible within the teachings of the various embodiments. For example, the additional embodiments, as highlighted by the implementations described, provide additional examples of the open number of variations and uses for this type apparatus that is a means for improved technology for enhancing human task performance, in particular tasks associated with executive function, working memory, and mental-model elicitation elements. Thus, the scope should be determined by the appended claims and their legal equivalents, and not by the examples given.

### APPENDIX A

### Example Content for Mmed Tag Clouds

### Glossary of Related Keywords, Concepts, and Topics (Wikipedia)

The following semi-colon separated sampling of related keywords, topics, and concepts are further defined and described within their respective Wikipedia pages (http://en.wikipedia.org; last access 1 Jun. 2012): Aboutness; Abstract Data Structure; Abstract object; Abstract strategy game; Abstraction; Academic discipline; Accelerating change; Active listening; Activity Diagram; Actor model; Actor model theory; Adaptive Control; Adaptive System; Adaptive Technology; Affect; Affect (psychology); Affect display; Affectional bond; Affective computing; Affective neuroscience; Affective science; Agent; Agent Architecture; Ambiguity; Analogy; Animal cognition; Archetype; Argument map; Arousal; Artificial intelligence; Artificial Neural Network; Association (object-oriented programming); Association (psychology); Association of Ideas; Attachment theory; Attention; Attention management; Attribute-value system; Augmented learning; Autobiographical memory; Automation; Awareness; Behavioral neuroscience; Belief; Bibliographic database; Big Five personality traits; Biomimetic; Bionics; Body of Knowledge; Brain; Brain—computer interface; Brain implant; Brainstorming; Business process automation; Business process illustration; Business process management; Business process mapping; Business Process Model and Notation; Business process modeling; Business process reengineering; Canonical; Canonical form; Canonical Model; Canonical Schema pattern; Career; Career development; Categorization; Causality; Central nervous system; Chain of events; Change Management; Chart; Chunking (psychology); Co-creation; Coaching; Cochlear implant; Cognition; Cognitive development; Cognitive dissonance; Cognitive map; Cognitive module; Cognitive style; Cognitive synonymy; Coherence theory of truth; Coherentism; Collaboration; Collaboration platform; Collaborative intelligence; Collaborative software; Collaborative working environment; Collective intelligence; Comic book; Comics; Common knowledge; Common sense; Commonsense knowledge base; Commonsense reasoning; Communication studies; Composition over inheritance; Computational neuroscience; Computational semantics; Computer-Based Assessment; Computer-supported collaboration; Computer-supported collaborative learning; Computer supported cooperative work; Consciousness; Concept; Concept Map; Concept Mining; Conceptual Clustering; Conceptual graph; Constructivist epistemology; Collaboration; Collaborative information seeking; Collaborative search engine; Conceptual Metaphor; Conceptual Model; Conceptual model (computer science); Conceptual Schema; Conformity assessment; Connotation; Consensus reality; Consonance and dissonance; Content management system; Controlled natural language; Controlled vocabulary; Conventional wisdom; Convergent thinking; Corrective lens; Creative visualization; Critical Thinking; Crowdsourcing; Data Model; Data Modeling; Data presentation architecture; Data Processing; Data Processor; Data Structure; Data visualization; Database; Database management system; Database model; Declarative memory; Deductive reasoning; Deferred gratification; Definition; Degree of truth; Democratization of knowledge; Denotation; Depiction; Design pattern; Developmental Biology; Developmental Psychology; Diagrammatic Reasoning; Dialogue; Dichotomy; Dictionary; Discipline; Distributed computing; Divergent thinking; Doctrine of the Mean; Domain analysis; Domain engineering; Domain knowledge; Domain model; Dyad (Greek philosophy); Ecological Genetics; Ecosystem; Effect; Effectiveness; Efficacy; Efficiency; Embodied cognition; Embodied cognitive science; Emergence; Emergent organization; Emotion; Emotional intelligence; Empathy; Encapsulation (object-oriented programming); Endophenotype; Enlightened self-interest; Enterprise Architecture; Enterprise Architecture Framework; Enterprise Modelling; Enterprise Resource Planning; Entity-attribute-value model; Episode; Episodic memory; Epistemology; Ethology; Evolutionary Biology; Evolutionary Developmental Biology; Evolutionary neuroscience; Evolutionary psychology; Executive Functions; Exocortex; Experience; Experimental psychology; Expert Elicitation; Explicit knowledge; Exploratory data analysis; Exploratory search; Extension (semantics); Extensional definition; Externalization; Faceted classification; Faceted search; Fact; Feeling; Fight-or-flight response; Figure-ground (perception); First-person narrative; Five Ws; Fixed action pattern; Flowchart; Folksonomy; Free association (psychology); Free recall; Full Genome Sequencing; Functional Requirement; Futurology; Fuzzy logic; Genetics; Genome; Genomics; Goal; Goal modeling; Goal setting; Goal theory; Graph (mathematics); Graph (data structure); Graph theory; Graphic communication; Graphic novel; Graphical language; Graphical model; GRASP (object-oriented design); Ground truth; Hedonistic relevance; Hermeneutic circle; Heuristic; Hierarchical Classifier; Hierarchical Control System; Hierarchical database model; Hierarchical organization; Hierarchical query; Hierarchy; Holland Codes; Human-based computation; Human—computer information retrieval; Human—computer interaction; Human evolution; Hunter-gatherer; Hyperlink; Hypermedia; Hypertext; Human ecology; Human enhancement; Hysteresis; Idea; Ideagoras; Identity formation; Ideogram; Ideology; Illustration; Image schema; Implicit Association Test; Implicit memory; Index term; Individual; Individual differences psychology; Individualism; Individuation; Inductive reasoning; Industrial and organizational psychology; Information; Information Architecture; Information Design; Information explosion; Information Extraction; Information Foraging; Information graphics; Information hiding; Information overload; Information Retrieval; Information seeking; Information seeking behavior; Information Theory; Information visualization; Infrastructure; Inheritance (object-oriented programming); Institutional memory; Instructional theory; Integrated Collaboration Environment (ICE); Intelligence; Intelligence amplification; Intelligent agent; Intention; Intensional definition; Intentionality; Interaction; Interaction Styles; Interactome; Interactive computation; Interconnectivity; Interdependence; Internal monologue; Internet; Interrogative word; ISO/TC 37; Keywords; Knowledge; Knowledge base; Knowledge-based systems; Knowledge Discovery; Knowledge engineering; Knowledge Management; Knowledge Modeling; Knowledge organization; Knowledge Representation; Knowledge transfer; Learning; Learning styles; Learning theory (education); Lexical database; Lexical definition; Lexical resource; Lexical semantics; Lexicography; Lexicon; Library classification; Lifecycle Management; Limbic system; Linked Data; List of concept mapping and mind mapping software; Index of perception-related articles; Lists of thinking-related topics; List of thought processes; Logical connective; Logical Data Model; Logical Schema; Logical truth; Logico-linguistic modeling; Machine Learning; Many-valued logic; Mass collaboration; Meaning (linguistics); Meaning (philosophy of language); Mechanism (philosophy); Media naturalness theory; Media richness theory; Memex; Memory; Mental event; Mental image; Mental Model; Mental Process; Mental property; Mental representation; Mentalization; Message; Meta-Ontology; Meta-Process Modeling; Metacognition; Metacommunicative competence; Metadata; Metamodeling; Metaphor; Metastability; Middle way; Mind; Mind-blindness; Mind map; Mixture (probability); Mixture model; Mnemonic; Model; Model-Driven Architecture; Model-Driven Engineering; Modeling language; Models of collaborative tagging; Modularity; Modularity of Mind; Molecular Biology; Molecular Genetics; Molecular Neuroscience; Molecular Phylogenetics; Motivation; Multi-agent system; Multi-objective Optimization; Multidisciplinary Design Optimization; Multilayered Architecture; Multitier Architecture; Myers-Briggs Type Indicator; Narrative; Narrative mode; Narrative structure; Narratology; Navigational database; Neo-Piagetian theories of cognitive development; Neural engineering; Neurobiology; Neurocognitive; Neuroethology; Neurophenomenology; Neuroprosthetics; Neuropsychiatry; Neuropsychological assessment; Neuropsychological Test; Neuropsychology; Neuroscience; Neuroscience and Intelligence; Neurotechnology; Nervous system; Nomenclature; Nonverbal communication; Noumenon; Object (computer science); Object (philosophy); Object database; Object-oriented analysis and design; Object-oriented design; Object-oriented programming; Objective (goal); Objectification; Obliteration by incorporation; Online book; Ontology; Ontology (information science); Ontology learning; Opposite (semantics); Oral tradition; Organism; Organization; Organizational Behavior; Organizational Development; Organizational storytelling; Organizational studies; Outline of self; Outlier; Ownership; Panel (comics); Paradigm; Paralanguage; Parameter; Parametric model; Parametrization; Participatory design; Participatory organization; Pattern; Pattern language; Pedagogy; Pedagogical patterns; Peer review; Perception; Performance Engineering; Performance Improvement; Performance Indicator; Persistence (computer science); Persistent data structure; Personal information management; Personal knowledge management; Personal organizer; Personal wiki; Personality psychology; Personality type; Perspective (cognitive); Phenomenology (philosophy); Phenomenology (psychology); Phenomenon; Phenotype; Phenotypic Trait; Philosophy of mind; Pictogram; Picture book; Planning; Planning (cognitive); Pleasure; Pleasure center; Preference elicitation; Priming (psychology); Principle; Principle of bivalence; Principle of individuation; Proactivity (aka Proactive); Problem domain; Problem finding; Problem of universals; Problem shaping; Problem Solving; Problem statement; Procedural memory; Process; Process Architecture; Process Capability; Process Control; Process Engineering; Process Improvement; Process Management; Process Management (computing); Process Modeling; Process ontology; Process Optimization; Process Reengineering; Process Theory; Professional development; Project management; Proposition; Prosopagnosia; Proteomics; Psychogenomics; Psychology; Psychology of self; Psychoanalysis; Psychological egoism; Psychological Types; Psychological typologies; Psychometrics; Psychophysiology; Qualia; Rational egoism; Rationality; Reality; Reason; Reciprocity (social psychology); Reference architecture; Reference model; Relational model; Requirement; Requirements Analysis; Requirements Elicitation; Resonance; Resource; Resource Allocation; Resource Management; Result; Reward system; Rhythm; Robotics; Rule of thumb; Salience (language); Salience (neuroscience); Scenario; Schema; Schematic; Scientific modelling; Scientific visualization; Self; Self-Awareness; Self-Concept; Self-Control; Self-Diagnosis; Self-Efficacy; Self-esteem; Self-help; Self-interest; Self-Knowledge; Self-Motivation; Self-Organization; Self-Ownership; Semantics; Semantic computing; Semantic desktop; Semantic lexicon; Semantic memory; Semantic network; Semantic similarity; Semantic spectrum; Semantic Web; Semi-structured data; Semiotics; Sensemaking; Separation of Concerns; Sequence; Serial (literature); Service Oriented Architecture; Service Oriented Modeling; Sign (semiotics); Situation awareness; Situated cognition; Social cognition; Social constructionism; Social epistemology; Social neuroscience; Social Semantic Web; Social software; Social stratification; Socially Distributed Cognition; Society of Mind; Sociocultural evolution; Soft systems methodology; Spatial visualization ability; Specification (technical standard); Specification language; Speech balloon; Spontaneous order; Spreading activation; Standardization; Statistical model; Statistical Signal Processing; Statistics; Stigmergy; Storytelling; Stream of consciousness (narrative mode); Stream of consciousness (psychology); Stress (biology); Strong Interest Inventory; Stroop effect; Structural functionalism; Subject indexing; Subtext; Subvocalization; Suffering; Sweet spot (sports); Symbol; Symbol grounding; Symbolic interactionism; Sympathetic nervous system; Synonym; Synonym ring; Synthesis; System; Systematics; System of Systems Engineering; System-of-Systems; Systems Analysis; Systems Architecture; Systems Biology; Systems Design; Systems Ecology; Systems Engineering; Systems Engineering Process; Systems intelligence; Systems Philosophy; Systems Science; Systems Theory; Systems Thinking; Swim lane; Tacit knowledge; Tag (metadata); Tag cloud; Taxonomy; Teachable moment; Technological singularity; Tempo; Temporal discounting; Terminology; Terminology extraction; Theory of Forms; Theory of Mind; Theory of multiple intelligences; Thesaurus; Thought; Time horizon; Time management; Time preference; Topic Maps; Train of thought; Training and development; Trait theory; Transdisciplinary studies; Transfer of learning; Truth; Truth value; Type—token distinction; Typography; Uncertainty; Unconscious communication; Unconscious mind; Understanding; Universal (metaphysics); Upper ontology (information science); Value Chain; Value engineering; Value Network; Value Networks; Value theory; Visual analytics; Visual communication; Visual Language; Visual learning; Visual modularity; Visual perception; Visual prosthesis; Visual reasoning; Visual system; Visual thinking; Visualization (computer graphics); Vocabulary; Web fiction; Wicked problem; Wiki; Wikinomics: How Mass Collaboration Changes Everything; Wikipedia; Wikipedia in culture; Wisdom; Wisdom of the crowd; Wise old man; Wise Old Woman/Man; Word Association; World view; Work engagement; WordNet; Workflow; Working memory; World Wide Web; Zaltman Metaphor Elicitation Technique.

### Tag Cloud of Related Prior Art Patents and Applications (USPTO)

U.S. Pat. No. 7,689,522 Method and system of organizing information based on human thought processes; U.S. Pat. No. 7,689,520 Machine learning system and method for ranking sets of data using a pairing cost function; U.S. Pat. No. 7,689,437 System for monitoring health, wellness and fitness; U.S. Pat. No. 7,685,118 Method using ontology and user query processing to solve inventor problems and user problems; U.S. Pat. No. 7,685,085 System and method to facilitate user thinking about an arbitrary problem with output and interfaces to external systems, components and resources; U.S. Pat. No. 7,672,950 Method and apparatus for selecting, analyzing, and visualizing related database records as a network; U.S. Pat. No. 7,672,908 Intent-based information processing and updates in association with a service agent; U.S. Pat. No. 7,672,854 Data storage management driven by business objectives; U.S. Pat. No. 7,668,746 Human resource assessment; U.S. Pat. No. 7,665,035 Content selection apparatus, system, and method; U.S. Pat. No. 7,660,820 Context-based heterogeneous information integration system; U.S. Pat. No. 7,647,283 Method, system, and computer program product for adaptively learning user preferences for smart services; U.S. Pat. No. 7,644,360 Patent claims analysis system and method; U.S. Pat. No. 7,644,101 System for generating and managing context information; U.S. Pat. No. 7,644,052 System and method of building and using hierarchical knowledge structures; U.S. Pat. No. 7,644,048 System, method and software for cognitive automation; U.S. Pat. No. 7,644,047 Semantic similarity based document retrieval; U.S. Pat. No. 7,644,006 Semantically investigating business processes; U.S. Pat. No. 7,640,497 Transforming a hierarchical data structure according to requirements specified in a transformation template; U.S. Pat. No. 7,640,221 Plan and candidate plan based system for achieving one or more goals and sub-goals; U.S. Pat. No. 7,640,220 Optimal taxonomy layer selection method; U.S. Pat. No. 7,636,702 Intersection ontologies for organizing data; U.S. Pat. No. 7,630,946 System for folder classification based on folder content similarity and dissimilarity; U.S. Pat. No. 7,621,871 Systems and methods for monitoring and evaluating individual performance; U.S. Pat. No. 7,613,664 Systems and methods for determining user interests; U.S. Pat. No. 7,596,537 System and method of facilitating and evaluating user thinking about an arbitrary problem using an archetype process; U.S. Pat. No. 7,587,664 Method and system for profiling users based on their relationships with content topics; U.S. Pat. No. 7,580,944 Business intelligent architecture system and method; U.S. Pat. No. 7,567,943 System and method for composition of mappings given by dependencies; U.S. Pat. No. 7,562,085 Systems and methods for displaying linked information in a sorted context; U.S. Pat. No. 7,562,082 Method and system for detecting user intentions in retrieval of hint sentences; U.S. Pat. No. 7,555,476 Apparatus and methods for organizing and/or presenting data; U.S. Pat. No. 7,552,199 Method for automatic skill-gap evaluation; U.S. Pat. No. 7,546,278 Correlating categories using taxonomy distance and term space distance; U.S. Pat. No. 7,543,286 Method and system for mapping tags to classes using namespaces; U.S. Pat. No. 7,533,105 Visual association of content in a content framework system; U.S. Pat. No. 7,526,465 Human-machine interactions; U.S. Pat. No. 7,523,077 Knowledge repository using configuration and document templates; U.S. Pat. No. 7,512,576 Automatically generated ontology by combining structured and/or semi-structured knowledge sources; U.S. Pat. No. 7,512,575 Automated integration of terminological information into a knowledge base; U.S. Pat. No. 7,496,583 Property tree for metadata navigation and assignment; U.S. Pat. No. 7,472,345 Document creation system and method using knowledge base, precedence, and integrated rules; U.S. Pat. No. 7,467,232 Search enhancement system and method having rankings, explicitly specified by the user, based upon applicability and validity of search parameters in regard to a subject matter; U.S. Pat. No. 7,467,095 Strategic planning and optimization system; U.S. Pat. No. 7,458,035 System and method for selecting an item in a list of items and associated products; U.S. Pat. No. 7,457,768 Methods and apparatus for predicting and selectively collecting preferences based on personality diagnosis; U.S. Pat. No. 7,447,699 Context-based heterogeneous information integration system; U.S. Pat. No. 7,444,315 Virtual community generation; U.S. Pat. No. 7,433,852 Runtime program regression analysis tool for a simulation engine; U.S. Pat. No. 7,428,532 System and method of client server aggregate transformation; U.S. Pat. No. 7,428,518 Simulation enabled accounting tutorial system; U.S. Pat. No. 7,428,517 Data integration and knowledge management solution; U.S. Pat. No. 7,409,336 Method and system for searching data based on identified subset of categories and relevance-scored text representation-category combinations; U.S. Pat. No. 7,390,191 Computer system configured to sequence multi-day training utilizing a database; U.S. Pat. No. 7,389,208 System and method for dynamic knowledge construction; U.S. Pat. No. 7,383,251 Method and apparatus for gathering and evaluating information; U.S. Pat. No. 7,364,432 Methods of selecting Lock-In Training courses and sessions; U.S. Pat. No. 7,363,593 System and method for presenting information organized by hierarchical levels; U.S. Pat. No. 7,359,831 Diagnostic context; U.S. Pat. No. 7,357,640 Lock-In Training system; U.S. Pat. No. 7,347,694 Method and apparatus for screening aspects of vision development and visual processing related to cognitive development and learning on the Internet; U.S. Pat. No. 7,333,967 Method and system for automatic computation creativity and specifically for story generation; U.S. Pat. No. 7,330,818 Health and life expectancy management system; U.S. Pat. No. 7,325,201 System and method for manipulating content in a hierarchical data-driven search and navigation system; U.S. Pat. No. 7,309,315 Apparatus, method and computer program product to facilitate ordinary visual perception via an early perceptual-motor extraction of relational information from a light stimuli array to trigger an overall visual-sensory motor integration in a subject; U.S. Pat. No. 7,302,418 Trade-off/semantic networks; U.S. Pat. No. 7,293,002 Self-organizing data driven learning hardware with local interconnections; U.S. Pat. No. 7,280,991 Creating collaborative simulations for creating collaborative simulations with multiple roles for a single student; U.S. Pat. No. 7,264,474 Personality style method; U.S. Pat. No. 7,249,117 Knowledge discovery agent system and method; U.S. Pat. No. 7,247,025 Sequential reasoning testing system and method; U.S. Pat. No. 7,243,102 Machine directed improvement of ranking algorithms; U.S. Pat. No. 7,234,140 Method for creating a workflow; U.S. Pat. No. 7,211,050 System for enhancement of neurophysiological processes; U.S. Pat. No. 7,207,804 Application of multi-media technology to computer administered vocational personnel assessment; U.S. Pat. No. 7,194,444 Goal based flow of a control presentation system; U.S. Pat. No. 7,188,141 Method and system for collaborative web research; U.S. Pat. No. 7,186,116 System and method for improving memory capacity of a user; U.S. Pat. No. 7,182,601 Interactive toy and methods for exploring emotional experience; U.S. Pat. No. 7,162,488 Systems, methods, and user interfaces for storing, searching, navigating, and retrieving electronic information; U.S. Pat. No. 7,156,665 Goal based educational system with support for dynamic tailored feedback; U.S. Pat. No. 7,153,140 Training system and method for improving user knowledge and skills; U.S. Pat. No. 7,152,092 Creating chat rooms with multiple roles for multiple participants; U.S. Pat. No. 7,137,819 Apparatus, system, and method for teaching sequencing principles; U.S. Pat. No. 7,137,062 System and method for hierarchical segmentation with latent semantic indexing in scale space; U.S. Pat. No. 7,136,791 Story-based organizational assessment and effect system; U.S. Pat. No. 7,117,434 Graphical web browsing interface for spatial data navigation and method of navigating data blocks; U.S. Pat. No. 7,117,189 Simulation system for a simulation engine with a help website and processing engine; U.S. Pat. No. 7,117,131 Method for characterizing a complex system; U.S. Pat. No. 7,110,988 Automated system and method for creating aligned goals; U.S. Pat. No. 7,089,222 Goal based system tailored to the characteristics of a particular user; U.S. Pat. No. 7,087,015 Neurological pathology diagnostic apparatus and methods; U.S. Pat. No. 7,082,436 Storing and retrieving the visual form of data; U.S. Pat. No. 7,074,128 Method and system for enhancing memorization by using a mnemonic display; U.S. Pat. No. 7,065,513 Simulation enabled feedback system; U.S. Pat. No. 7,065,512 Dynamic toolbar in a tutorial system; U.S. Pat. No. 7,054,848 Goal based system utilizing a time based model; U.S. Pat. No. 7,052,277 System and method for adaptive learning; U.S. Pat. No. 7,031,651 System and method of matching teachers with students to facilitate conducting online private instruction over a global network; U.S. Pat. No. 7,024,398 Computer-implemented methods and apparatus for alleviating abnormal behaviors; U.S. Pat. No. 7,007,018 Business vocabulary data storage using multiple inter-related hierarchies; U.S. Pat. No. 6,996,768 Electric publishing system and method of operation generating web pages personalized to a user's optimum learning mode; U.S. Pat. No. 6,985,898 System and method for visually representing a hierarchical database objects and their similarity relationships to other objects in the database; U.S. Pat. No. 6,974,324 Adaptable device for delimiting and organizing spaces and volumes; U.S. Pat. No. 6,970,858 Goal based system utilizing an activity table; U.S. Pat. No. 6,947,951 System for modeling a business; U.S. Pat. No. 6,940,509 Systems and methods for improving concept landscape visualizations as a data analysis tool; U.S. Pat. No. 6,920,231 Method and system of transitive matching for object recognition, in particular for biometric searches; U.S. Pat. No. 6,907,417 System and method for converting node-and-link knowledge representations to outline format; U.S. Pat. No. 6,901,390 Control system for controlling object using pseudo-emotions and pseudo-personality generated in the object; U.S. Pat. No. 6,896,656 Neurological testing apparatus; U.S. Pat. No. 6,874,123 Three-dimensional model to facilitate user comprehension and management of information; U.S. Pat. No. 6,863,533 Reading teaching aid; U.S. Pat. No. 6,850,891 Method and system of converting data and judgements to values or priorities; U.S. Pat. No. 6,836,894 Systems and methods for exploratory analysis of data for event management; U.S. Pat. No. 6,836,773 Enterprise web mining system and method; U.S. Pat. No. 6,778,970 Topological methods to organize semantic network data flows for conversational applications; U.S. Pat. No. 6,767,213 System and method for assessing organizational leadership potential through the use of metacognitive predictors; U.S. Pat. No. 6,749,432 Education system challenging a subject's physiologic and kinesthetic systems to synergistically enhance cognitive function; U.S. Pat. No. 6,745,170 Goal based educational system with support for dynamic characteristic tuning; U.S. Pat. No. 6,743,167 Method and system for predicting human cognitive performance using data from an actigraph; U.S. Pat. No. 6,741,833 Learning activity platform and method for teaching a foreign language over a network; U.S. Pat. No. 6,740,032 Method and system for predicting human cognitive performance; U.S. Pat. No. 6,731,927 System and method for context association; U.S. Pat. No. 6,712,615 High-precision cognitive performance test battery suitable for internet and non-internet use; U.S. Pat. No. 6,711,577 Data mining and visualization techniques; U.S. Pat. No. 6,705,869 Method and system for interactive communication skill training; U.S. Pat. No. 6,688,890 Device, method and computer program product for measuring a physical or physiological activity by a subject and for assessing the psychosomatic state of the subject; U.S. Pat. No. 6,684,221 Uniform hierarchical information classification and mapping system; U.S. Pat. No. 6,680,675 Interactive to-do list item notification system including GPS interface; U.S. Pat. No. 6,678,677 Apparatus and method for information retrieval using self-appending semantic lattice; U.S. Pat. No. 6,675,159 Concept-based search and retrieval system; U.S. Pat. No. 6,669,481 Neurocognitive assessment apparatus and method; U.S. Pat. No. 6,663,392 Sequential reasoning testing system and method; U.S. Pat. No. 6,658,398 Goal based educational system utilizing a remediation object; U.S. Pat. No. 6,650,251 Sensory monitor with embedded messaging element; U.S. Pat. No. 6,641,400 Multi-disciplinary educational tool; U.S. Pat. No. 6,640,216 Human resource knowledge modeling and delivery system; U.S. Pat. No. 6,632,174 Method and apparatus for testing and training cognitive ability; U.S. Pat. No. 6,629,935 Method and apparatus for diagnosis of a mood disorder or predisposition therefor; U.S. Pat. No. 6,629,097 Displaying implicit associations among items in loosely-structured data sets; U.S. Pat. No. 6,626,676 Electroencephalograph based biofeedback system for improving learning skills; U.S. Pat. No. 6,618,727 System and method for performing similarity searching; U.S. Pat. No. 6,618,723 Interpersonal development communications system and directory; U.S. Pat. No. 6,615,197 Brain programmer for increasing human information processing capacity; U.S. Pat. No. 6,613,101 Method and apparatus for organizing information in a computer system; U.S. Pat. No. 6,611,822 System method and article of manufacture for creating collaborative application sharing; U.S. Pat. No. 6,585,519 Uniform motivation for multiple computer-assisted training systems; U.S. Pat. No. 6,581,048 3-brain architecture for an intelligent decision and control system; U.S. Pat. No. 6,565,359 Remote computer-implemented methods for cognitive and perceptual testing; U.S. Pat. No. 6,553,252 Method and system for predicting human cognitive performance; U.S. Pat. No. 6,549,893 System, method and article of manufacture for a goal based system utilizing a time based model; U.S. Pat. No. 6,544,042 Computerized practice test and cross-sell system; U.S. Pat. No. 6,542,889 Methods and apparatus for similarity text search based on conceptual indexing; U.S. Pat. No. 6,542,880 System, method and article of manufacture for a goal based system utilizing a table based architecture; U.S. Pat. No. 6,539,375 Method and system for generating and using a computer user's personal interest profile; U.S. Pat. No. 6,535,861 Goal based educational system with support for dynamic characteristics tuning using a spread sheet object; U.S. Pat. No. 6,533,584 Uniform motivation for multiple computer-assisted training systems; U.S. Pat. No. 6,530,884 Method and system for predicting human cognitive performance; U.S. Pat. No. 6,527,715 System and method for predicting human cognitive performance using data from an actigraph; U.S. Pat. No. 6,517,480 Neurological testing apparatus; U.S. Pat. No. 6,497,577 Systems and methods for improving emotional awareness and self-mastery; U.S. Pat. No. 6,494,720 Methods for objectification of subjective classifications; U.S. Pat. No. 6,493,690 Goal based educational system with personalized coaching; U.S. Pat. No. 6,491,525 Application of multi-media technology to psychological and educational assessment tools; U.S. Pat. No. 6,480,841 Information processing apparatus capable of automatically setting degree of relevance between keywords, keyword attaching method and keyword auto-attaching apparatus; U.S. Pat. No. 6,453,315 Meaning-based information organization and retrieval; U.S. Pat. No. 6,453,312 System and method for developing a selectably-expandable concept-based search; U.S. Pat. No. 6,450,820 Method and apparatus for encouraging physiological self-regulation through modulation of an operator's control input to a video game or training simulator; U.S. Pat. No. 6,446,061 Taxonomy generation for document collections; U.S. Pat. No. 6,445,968 Task manager; U.S. Pat. No. 6,435,878 Interactive computer program for measuring and analyzing mental ability; U.S. Pat. No. 6,419,629 Method for predicting human cognitive performance; U.S. Pat. No. 6,416,472 Method and device for measuring cognitive efficiency; U.S. Pat. No. 6,416,328 Interconnective and interrelational information interface system; U.S. Pat. No. 6,402,520 Electroencephalograph based biofeedback system for improving learning skills; U.S. Pat. No. 7,398,512 Method, system, and software for mapping and displaying process objects at different levels of abstraction; U.S. Pat. No. 6,389,405 Processing system for identifying relationships between concepts; U.S. Pat. No. 6,385,602 Presentation of search results using dynamic categorization; U.S. Pat. No. 6,385,590 Method and system for determining the effectiveness of a stimulus; U.S. Pat. No. 6,385,581 System and method of providing emotive background sound to text; U.S. Pat. No. 6,361,326 System for instruction thinking skills; U.S. Pat. No. 6,341,303 System and method for scheduling a resource according to a preconfigured plan; U.S. Pat. No. 6,341,267 Methods, systems and apparatuses for matching individuals with behavioral requirements and for managing providers of services to evaluate or increase individuals' behavioral capabilities; U.S. Pat. No. 6,338,628 Personal training and development delivery system; U.S. Pat. No. 6,327,593 Automated system and method for capturing and managing user knowledge within a search system; U.S. Pat. No. 6,327,590 System and method for collaborative ranking of search results employing user and group profiles derived from document collection content analysis; U.S. Pat. No. 6,315,569 Metaphor elicitation technique with physiological function monitoring; U.S. Pat. No. 6,280,198 Remote computer implemented methods for cognitive testing; U.S. Pat. No. 6,273,725 Process for teaching students multiple curriculum subjects through the use of a theatrical production; U.S. Pat. No. 6,272,478 Data mining apparatus for discovering association rules existing between attributes of data; U.S. Pat. No. 6,266,649 Collaborative recommendations using item-to-item similarity mappings; U.S. Pat. No. 6,263,326 Method product apparatus for modulations; U.S. Pat. No. 6,260,022 Modular microprocessor-based diagnostic measurement apparatus and method for psychological conditions; U.S. Pat. No. 6,249,780 Control system for controlling object using pseudo-emotions and pseudo-personality generated in the object; U.S. Pat. No. 6,241,686 System and method for predicting human cognitive performance using data from an actigraph; U.S. Pat. No. 6,236,994 Method and apparatus for the integration of information and knowledge; U.S. Pat. No. 6,236,768 Method and apparatus for automated, context-dependent retrieval of information; U.S. Pat. No. 6,233,592 System for electronic publishing; U.S. Pat. No. 6,233,575 Multilevel taxonomy based on features derived from training documents classification using fisher values as discrimination values; U.S. Pat. No. 6,231,344 Prophylactic reduction and remediation of schizophrenic impairments through interactive behavioral training; U.S. Pat. No. 6,230,173 Method for creating structured documents in a publishing system; U.S. Pat. No. 6,230,111 Control system for controlling object using pseudo-emotions and pseudo-personality generated in the object; U.S. Pat. No. 6,212,526 Method for apparatus for efficient mining of classification models from databases; U.S. Pat. No. 6,185,549 Method for mining association rules in data; U.S. Pat. No. 6,167,390 Facet classification neural network; U.S. Pat. No. 6,166,739 Method and apparatus for organizing and processing information using a digital computer; U.S. Pat. No. 6,138,085 Inferring semantic relations; U.S. Pat. No. 6,134,539 System, method and article of manufacture for a goal based education and reporting system; U.S. Pat. No. 6,119,114 Method and apparatus for dynamic relevance ranking; U.S. Pat. No. 6,108,619 Method and apparatus for semantic characterization of general content; U.S. Pat. No. 6,108,004 GUI guide for data mining; U.S. Pat. No. 6,101,515 Learning system for classification of terminology; U.S. Pat. No. 6,101,481 Task management system; U.S. Pat. No. 6,092,058 Automatic aiding of human cognitive functions with computerized displays; U.S. Pat. No. 6,088,702 Group publishing system; U.S. Pat. No. 6,085,187 Method and apparatus for navigating multiple inheritance concept hierarchies; U.S. Pat. No. 6,078,916 Method for organizing information; U.S. Pat. No. 6,073,115 Virtual reality generator for displaying abstract information; U.S. Pat. No. 6,064,971 Adaptive knowledge base; U.S. Pat. No. 6,061,675 Methods and apparatus for classifying terminology utilizing a knowledge catalog; U.S. Pat. No. 6,058,367 System for matching users based upon responses to sensory stimuli; U.S. Pat. No. 6,055,544 Generation of chunks of a long document for an electronic book system; U.S. Pat. No. 6,053,739 Measurement of attention span and attention deficits; U.S. Pat. No. 6,049,797 Method, apparatus and programmed medium for clustering databases with categorical attributes; U.S. Pat. No. 6,037,944 Method and apparatus for displaying a thought network from a thought's perspective; U.S. Pat. No. 6,035,300 Method and apparatus for generating a user interface from the entity/attribute/relationship model of a database; U.S. Pat. No. 6,032,141 System, method and article of manufacture for a goal based educational system with support for dynamic tailored feedback; U.S. Pat. No. 6,030,226 Application of multi-media technology to psychological and educational assessment tools; U.S. Pat. No. 6,007,340 Method and system for measuring leadership effectiveness; U.S. Pat. No. 5,999,940 Interactive information discovery tool and methodology; U.S. Pat. No. 5,991,751 System, method, and computer program product for patent-centric and group-oriented data processing; U.S. Pat. No. 5,989,034 Information organization method, information organization sheet, and display apparatus; U.S. Pat. No. 5,980,354 Storyboard toys for nurturing cognition and learning strategies; U.S. Pat. No. 5,954,511 Method for task education involving mental imaging; U.S. Pat. No. 5,954,510 Interactive goal-achievement system and method; U.S. Pat. No. 5,940,821 Information presentation in a knowledge base search and retrieval system; U.S. Pat. No. 5,940,801 Modular microprocessor-based diagnostic measurement apparatus and method for psychological conditions; U.S. Pat. No. 5,933,841 Structured document browser; U.S. Pat. No. 5,926,810 Universal schema system; U.S. Pat. No. 5,913,310 Method for diagnosis and treatment of psychological and emotional disorders using a microprocessor-based video game; U.S. Pat. No. 5,911,581 Interactive computer program for measuring and analyzing mental ability; U.S. Pat. No. 5,910,107 Computerized medical diagnostic and treatment advice method; U.S. Pat. No. 5,899,995 Method and apparatus for automatically organizing information; U.S. Pat. No. 5,890,905 Educational and life skills organizer/memory aid; U.S. Pat. No. 5,878,421 Information map; U.S. Pat. No. 5,875,446 System and method for hierarchically grouping and ranking a set of objects in a query context based on one or more relationships; U.S. Pat. No. 5,874,964 Method for modeling assignment of multiple memberships in multiple groups; U.S. Pat. No. 5,826,236 Method for allocating resources and processes for design and production plan scheduling; U.S. Pat. No. 5,812,134 User interface navigational system & method for interactive representation of information contained within a database; U.S. Pat. No. 5,809,266 Method and apparatus for generating reports using declarative tools; U.S. Pat. No. 5,795,155 Leadership assessment tool and method; U.S. Pat. No. 5,790,121 Clustering user interface; U.S. Pat. No. 5,778,362 Method and system for revealing information structures in collections of data items; U.S. Pat. No. 5,761,681 Method of substituting names in an electronic book; U.S. Pat. No. 5,745,895 Method for association of heterogeneous information; U.S. Pat. No. 5,743,742 System for measuring leadership effectiveness; U.S. Pat. No. 5,725,472 Psychotherapy apparatus and method for the inputting and shaping new emotional physiological and cognitive response patterns in patients; U.S. Pat. No. 5,722,418 Method for mediating social and behavioral processes in medicine and business through an interactive telecommunications guidance system; U.S. Pat. No. 5,721,910 Relational database system containing a multidimensional hierarchical model of interrelated subject categories with recognition capabilities; U.S. Pat. No. 5,717,914 Method for categorizing documents into subjects using relevance normalization for documents retrieved from an information retrieval system in response to a query; U.S. Pat. No. 5,704,017 Collaborative filtering utilizing a belief network; U.S. Pat. No. 5,697,790 Discipline System; U.S. Pat. No. 5,678,571 Method for treating medical conditions using a microprocessor-based video game; U.S. Pat. No. 5,678,038 Storing and retrieving heterogeneous classification systems utilizing globally unique identifiers; U.S. Pat. No. 5,673,369 Authoring knowledge-based systems using interactive directed graphs; U.S. Pat. No. 5,671,381 Method and apparatus for displaying data within a three-dimensional information landscape; U.S. Pat. No. 5,666,442 Comparison system for identifying the degree of similarity between objects by rendering a numeric measure of closeness, the system including all available information complete with errors and inaccuracies; U.S. Pat. No. 5,663,748 Electronic book having highlighting feature; U.S. Pat. No. 5,649,192 Self-organized information storage system; U.S. Pat. No. 5,644,740 Method and apparatus for displaying items of information organized in a hierarchical structure; U.S. Pat. No. 5,639,242 Children's educational daily responsibilities learning system in game format; U.S. Pat. No. 5,615,341 System and method for mining generalized association rules in databases; U.S. Pat. No. 5,594,837 Method for representation of knowledge in a computer as a network database system; U.S. Pat. No. 5,557,722 Data processing system and method for representing, generating a representation of and random access rendering of electronic documents; U.S. Pat. No. 5,555,354 Method and apparatus for navigation within three-dimensional information landscape; U.S. Pat. No. 5,553,226 System for displaying concept networks; U.S. Pat. No. 5,535,322 Data processing system with improved work flow system and method; U.S. Pat. No. 5,528,735 Method and apparatus for displaying data within a three-dimensional information landscape; U.S. Pat. No. 5,506,937 Concept mapbased multimedia computer system for facilitating user understanding of a domain of knowledge; U.S. Pat. No. 5,490,097 System and method for modeling, analyzing and executing work process plans; U.S. Pat. No. 5,479,592 Method of simultaneously analyzing a plurality of performance statistics of an athlete; U.S. Pat. No. 5,479,574 Method and apparatus for adaptive classification; U.S. Pat. No. 5,447,166 Neurocognitive adaptive computer interface method and system based on on-line measurement of the user's mental effort; U.S. Pat. No. 5,436,830 Metaphor elicitation method and apparatus; U.S. Pat. No. 5,428,554 Hierarchical graph analysis method and apparatus; U.S. Pat. No. 5,418,946 Structured data classification device; U.S. Pat. No. 5,413,486 Interactive book; U.S. Pat. No. 5,408,663 Resource allocation methods; U.S. Pat. No. 5,388,196 Hierarchical shared books with database; U.S. Pat. No. 5,386,578 Method for sorting and merging in a data processing system using a matrix of cells; U.S. Pat. No. 5,372,509 Healthy choices play and reward kit; U.S. Pat. No. 5,371,807 Method and apparatus for text classification; U.S. Pat. No. 5,359,724 Method and apparatus for storing and retrieving multi-dimensional data in computer memory; U.S. Pat. No. 5,344,324 Apparatus and method for testing human performance; U.S. Pat. No. 5,331,554 Method and apparatus for semantic pattern matching for text retrieval; U.S. Pat. No. 5,321,833 Adaptive ranking system for information retrieval; U.S. Pat. No. 5,306,006 Structure for uniting shapes and images with words; U.S. Pat. No. 5,303,170 System and method for process modelling and project planning; U.S. Pat. No. 5,293,479 Design tool and method for preparing parametric assemblies; U.S. Pat. No. 5,283,856 Event-driven rule-based messaging system; U.S. Pat. No. 5,257,185 Interactive, cross-referenced knowledge system; U.S. Pat. No. 5,251,294 Accessing, assembling, and using bodies of information; U.S. Pat. No. 5,241,621 Management issue recognition and resolution knowledge processor; U.S. Pat. No. 5,233,688 Method and apparatus for process monitoring and method of constructing network diagram for process monitoring; U.S. Pat. No. 5,217,379 Personal therapeutic device and method; U.S. Pat. No. 5,206,949 Database search and record retrieval system which continuously displays category names during scrolling and selection of individually displayed search terms; U.S. Pat. No. 5,182,705 Computer system and method for work management; U.S. Pat. No. 5,179,643 Method of multi-dimensional analysis and display for a large volume of record information items and a system therefor; U.S. Pat. No. 5,173,051 Curriculum planning and publishing method; U.S. Pat. No. 5,167,505 Educational aides and methods; U.S. Pat. No. 5,165,030 Method and system for dynamic creation of data stream based upon system parameters and operator selections; U.S. Pat. No. 5,141,439 Keyword teaching and testing method; U.S. Pat. No. 5,130,924 System for defining relationships among document elements including logical relationships of elements in a multi-dimensional tabular specification; U.S. Pat. No. 5,121,330 Method and system for product restructuring; U.S. Pat. No. 5,072,412 User interface with multiple workspaces for sharing display system objects; U.S. Pat. No. 5,065,347 Hierarchical folders display; U.S. Pat. No. 5,061,185 Tactile enhancement method for progressively optimized reading; U.S. Pat. No. 5,056,021 Method and apparatus for abstracting concepts from natural language; U.S. Pat. No. 5,053,991 Content-addressable memory with soft-match capability; U.S. Pat. No. 5,040,987 Educational aid for word and numeral recognition; U.S. Pat. No. 5,021,976 Method and system for generating dynamic, interactive visual representations of information structures within a computer; U.S. Pat. No. 5,016,170 Task management; U.S. Pat. No. 5,013,246 Method of promoting self-esteem by assembling a personalized kit; U.S. Pat. No. 5,008,853 Representation of collaborative multi-user activities relative to shared structured data objects in a networked workstation environment; U.S. Pat. No. 5,002,491 Electronic classroom system enabling interactive self-paced learning; U.S. Pat. No. 4,985,697 Electronic book educational publishing method using buried reference materials and alternate learning levels; U.S. Pat. No. 4,964,063 System and method for frame and unit-like symbolic access to knowledge represented by conceptual structures; U.S. Pat. No. 4,962,475 Method for generating a document utilizing a plurality of windows associated with different data objects; U.S. Pat. No. 4,945,476 Interactive system and method for creating and editing a knowledge base for use as a computerized aid to the cognitive process of diagnosis; U.S. Pat. No. 4,945,475 Hierarchical file system to provide cataloging and retrieval of data; U.S. Pat. No. 4,936,778 Method and apparatus for producing comparative data; U.S. Pat. No. 4,912,671 Electronic dictionary; U.S. Pat. No. 4,879,648 Search system which continuously displays search terms during scrolling and selections of individually displayed data sets; U.S. Pat. No. 4,875,187 Processing apparatus for generating flow charts; U.S. Pat. No. 4,873,623 Process control interface with simultaneously displayed three level dynamic menu; U.S. Pat. No. 4,868,733 Document filing system with knowledge-base network of concept interconnected by generic, subsumption, and superclass relations; U.S. Pat. No. 4,852,019 Method and system for retrieval of stored graphs; U.S. Pat. No. 4,847,784 Knowledge based tutor; U.S. Pat. No. 4,839,853 Computer information retrieval using latent semantic structure; U.S. Pat. No. 4,815,005 Semantic network machine for artificial intelligence computer; U.S. Pat. No. 4,813,013 Schematic diagram generating system using library of general purpose interactively selectable graphic primitives to create special applications icons; U.S. Pat. No. 4,807,142 Screen manager multiple viewport for a multi-tasking data processing system; U.S. Pat. No. 4,803,625 Personal health monitor; U.S. Pat. No. 4,797,103 Learning board; U.S. Pat. No. 4,776,802 Learning aid and puzzle; U.S. Pat. No. 4,747,053 Electronic dictionary; U.S. Pat. No. 4,734,856 Autogeneric system; U.S. Pat. No. 4,730,259 Matrix controlled expert system producible from examples; U.S. Pat. No. 4,730,253 Tester for measuring impulsivity, vigilance, and distractibility; U.S. Pat. No. 4,729,381 Living body information recorder; U.S. Pat. No. 4,717,343 Method of changing a person's behavior; U.S. Pat. No. 4,683,891 Biomonitoring stress management method and device; U.S. Pat. No. 4,679,137 Process control interface system for designer and operator; U.S. Pat. No. 4,665,926 Method and apparatus for measuring the relaxation state of a person; U.S. Pat. No. 4,658,370 Knowledge engineering tool; U.S. Pat. No. 4,656,603 Schematic diagram generating system using library of general purpose interactively selectable graphic primitives to create special applications icons; U.S. Pat. No. 4,650,426 Skill evaluating apparatus and method; U.S. Pat. No. 4,628,483 One level sorting network; U.S. Pat. No. 4,573,927 Means and method of showing feelings; U.S. Pat. No. 4,544,360 Book reference list; U.S. Pat. No. 4,525,148 Multi-modal educational and entertainment system; U.S. Pat. No. 4,518,361 Method and apparatus for effecting and evaluating action upon visual imaging; U.S. Pat. No. 4,514,826 Relational algebra engine; U.S. Pat. No. 4,513,294 Physiological trend data recorder; U.S. Pat. No. 4,433,392 Interactive data retrieval apparatus; U.S. Pat. No. 4,428,732 Educational and amusement apparatus; U.S. Pat. No. 4,417,321 Qualifying and sorting file record data; U.S. Pat. No. 4,411,628 Electronic learning aid with picture book; U.S. Pat. No. 4,384,329 Retrieval of related linked linguistic expressions including synonyms and antonyms; U.S. Pat. No. 4,358,278 Learning and matching apparatus and method; U.S. Pat. No. 4,341,521 Psychotherapeutic device; U.S. Pat. No. 4,326,259 Self organizing general pattern class separator and identifier; U.S. Pat. No. 4,318,184 Information storage and retrieval system and method; U.S. Pat. No. 4,315,315 Graphical automatic programming; U.S. Pat. No. 4,275,449 Modelling arrangements; U.S. Pat. No. 4,270,182 Automated information input, storage, and retrieval system; U.S. Pat. No. 4,255,796 Associative information retrieval continuously guided by search status feedback; U.S. Pat. No. 4,240,213 Educational amusement device for matching words with non-verbal symbols; U.S. Pat. No. 4,218,760 Electronic dictionary with plug-in module intelligence; U.S. Pat. No. 4,159,417 Electronic book; U.S. Pat. No. 4,125,868 Typesetting terminal apparatus having searching and merging features; U.S. Pat. No. 4,107,852 Memorization aids; U.S. Pat. No. 4,060,915 Mental image enhancement apparatus utilizing computer systems; U.S. Pat. No. 4,008,529 Teaching apparatus and method; U.S. Pat. No. 4,006,541 Tactile learning device; U.S. Pat. No. 3,999,307 Teaching machine; U.S. Pat. No. 3,971,000 Computer-directed process control system with interactive display functions; U.S. Pat. No. 3,949,488 Educational associativity doll; U.S. Pat. No. 3,931,612 Sort apparatus and data processing system; U.S. Pat. No. 3,910,257 Medical Subject Monitoring Systems; U.S. Pat. No. 3,736,409 Management System And Method; U.S. Pat. No. 3,670,310 Method For Information Storage And Retrieval; U.S. Pat. No. 3,666,872 Teaching Machine; U.S. Pat. No. 3,613,266 Method And Means For Enhancing Mental Imaging Capabilities; U.S. Pat. No. 3,601,811 Learning Machine; U.S. Pat. No. 3,566,370 Automated Medical History Taking System; U.S. Pat. No. 3,533,086 Automatic System For Constructing And Recording Display Charts; U.S. Pat. No. 3,531,795 Bar-Type Display; U.S. Pat. No. 3,508,349 Educational Device; U.S. Pat. No. 3,435,422 Self-Organizing System; U.S. Pat. No. 3,388,381 Data Processing Means; U.S. Pat. No. 3,380,176 Self-Correcting Educational Device, Game And Associative Display; U.S. Pat. No. 3,357,115 Psychomotor Performance Testing Apparatus; U.S. Pat. No. 3,341,822 Method And Apparatus For Training Self-Organizing Networks; U.S. Pat. No. 3,275,986 Pattern Recognition Systems; U.S. Pat. No. 3,262,101 Generalized Self-Synthesizer; U.S. Pat. No. 3,221,308 Memory System; U.S. Pat. No. 3,103,648 Adaptive Neuron Having Improved Output; U.S. Pat. No. 3,052,041 Teaching Machine; U.S. Pat. No. 3,029,413 Sorting System With N-Line Sorting Switch; U.S. Pat. No. 2,984,822 Two-Way Data Compare-Sort Apparatus; U.S. Pat. No. 2,944,542 Detecting And Recording Physiological Changes Accompanying Emotion Stresses; U.S. Pat. No. 2,839,843 Educational Apparatus; U.S. Pat. No. 2,748,500 Educational Appliance; U.S. Pat. No. 2,481,109 Game Combining Jigsaw Puzzle And Quiz; U.S. Pat. No. 2,340,139 Indicating Climbing Device; U.S. Pat. No. 1,735,456 Educational Device; U.S. Pat. No. 1,656,030 Educational Material; U.S. Pat. No. 1,603,129 Outlining Device; U.S. Pat. No. 1,595,115 Folding Educational Device; U.S. Pat. No. 1,451,108 Game; U.S. Pat. No. 1,359,115 Educational Device; U.S. Pat. No. 1,256,100 Jig Saw Puzzle; U.S. Pat. No. 0,889,515 Educational Device; U.S. Pat. No. 0,736,140 Memorizer; U.S. Pat. No. 0,645,440 Educational Appliance; U.S. Pat. No. 0,601,811 Puzzle; U.S. Pat. No. 0,367,223 Illustrated Number-Cards; U.S. Pat. No. 0,318,823 Spelling Toy Or Puzzle; U.S. Pat. No. 0,179,023 Improvement In Picture-Puzzles; U.S. Pat. No. 0,171,507 Improvement In Dissected Picture And Letter Blocks; U.S. Pat. No. 0,110,213 Improvement In Sectional Images; 20100211603 Computer-aided methods and systems for pattern-based cognition from fragmented material; 20080108022 System and method for automatic driver evaluation; 20080021912 Tools and methods for semi-automatic schema matching; 20080004660 Systems and methods for improving a cognitive function; 20070299319 Cognitive Training Using A Continuous Performance Adaptive Procedure; 20070117073 Method and apparatus for developing a person's behavior; 20070112585 Cognition analysis; 20060003297 Language disorder assessment and associated methods; 20050273017 Collective brain measurement system and method; 20050053904 System and method for on-site cognitive efficacy assessment; 20050055369 Method and apparatus for semantic discovery and mapping between data sources; 20030182167 Goal management

### Tag Cloud of Related Publications (from Bibliographic Searches)

Adolphs, “Conceptual Challenges and Directions for Social Neuroscience,” 2010 (http://www.lizardphunk.org/skrivut/gvammen3/conceptual.pdf); Adolphs, “The Social Brain: Neural Basis of Social Knowledge,” 2009 (http://www.fil.ion.ucl.ac.uk/SocialClub/Adolphs2003Cognitive.pdf); Albus, “Mechanisms of planning and problem solving in the brain,” 1979 (http://citeseerx.ist.psu.edu/viewdoc/download?doi=10.1.1.141.3795&rep=rep1&type=pdf); Albus, “Outline for a Theory of Intelligence,” May/June 1991 (http://citeseerx.ist.psu.edu/viewdoc/download?doi=10.1.1.75.5504&rep=rep1&type=pdf); Amanjee et al., “Towards Validating A Framework Of Adaptive Schemata For Entrepreneurial Success” SA Journal of Industrial Psychology, (2006; http://sajip.co.za/index.php/sajip/article/view/434/389); Amigó et al., “General Factor of Personality Questionnaire (GFPQ): Only one Factor to Understand Personality?,” The Spanish Journal of Psychology, 2010, Vol. 13 No. 1, 5-17, (http://www.ucm.es/info/psi/docs/journal/v13_n1_{—}2010/art5.pdf); Anderson, “Genome as Commodity,” IEEE Spectrum, February 2010 (http://spectrum.ieee.org/biomedical/diagnostics/genome-as-commodity); Anderson, “Reality Isn't What It Used to Be: Theatrical Politics, Ready-to-Wear Religion, Global Myths, Primitive Chic, and Other Wonders of the Postmodern World,” 1992; Anderson, “The Truth about the Truth,” Tarcher, 1995; Anderson, “The Future of the Self: Inventing the Postmodern Person,” Tarcher/Putnam, 1997; Anderson, “All Connected Now: Life in the First Global Civilization,” Westview Press, 2001; Armstrong and Anthoney, “Personality facets and RIASEC interests: An integrated model,” 2009 (https://netfiles.uiuc.edu/jrounds/IIP/personality_interests_facets_jvb_{—}2009.pdf).; Armstrong and Day, “Holland's RIASEC Model as an Integrative Framework for Individual Differences,” Journal of Counseling Psychology, 2008 (https://netfiles.uiuc.edu/jrounds/IIP/Armstrong_JCP_{—}08.pdf); ATUS Homepage, “American Time-Use Survey Homepage,” last access 30 Jun. 2010 (http://www.bls.gov/tus/); Baars, “In the Theater of Consciousness: The Workspace of the Mind,” Oxford Press, 1997; Baars and Gage, “Cognition, Brain, and Consciousness: Introduction to Cognitive Neuroscience (2nd ed),” Academic Press, 2010; Bae, “A Computational Model of Narrative Generation for Surprise Arousal,” July 2009 (http://repository.lib.ncsu.edu/ir/handle/1840.16/4494); Baker, “Utilizing the Mind by Implementing a Plan for a Mental Training Program for the Tucson Fire Department,” March 2007 (http://www.usfa.dhs.gov/pdf/efop/efo40307.pdf); Barrick et al., “Meta-analysis of the relationship between the five-factor model of personality and holland's occupational types,” Personnel Psychology, 2003 (http://wehner.tamu.edu/mgmt.www/barrick/Pubs/2003_Barrick_Mount_Gupta.pdf); Bassham, “With Winning in Mind,” 1995 (www.mentalmanagement.com); Berger and Luckman, “The Social Construction of Reality: A Treatise in the Sociology of Knowledge,” 1967; BLS, “American Time Usage Survey,” Bureau of Labor Stats., 2009 (http://www.bls.gov/tus/); Bossche et al., “Team Learning: Building Shared Mental Models,” 2010 (http://dspace.ou.nl/bitstream/1820/2884/1/Team%20Learning%20-%20Building%20Shared%20Mental%20Models.pdf); Brandt, “Language and enunciation—A cognitive inquiry with special focus on conceptual integration in semiotic meaning construction,” 2010 (http://www.hum.au.dk/semiotics/docs2/pdf/brandt_line_phd/Brandt_manuscript.pdf); Bromberg, “Truth, human relatedness, and the analytic process: An interpersonal/relational perspective,” 2009 (http://www.ahealthymind.org/library/Bromberg%2009.pdf); Caine and Caine, “Understanding a Brain-Based Approach to Learning and Teaching,” (http://www.coe.iup.edu/grbieger/classes/curr910/Readings/Brainbasedlearning.pdf); Camerer et al., “Neuroeconomics: How Neuroscience Can Inform Economics,” Journal of Economic Literature, March 2005 (http://www.psycho.unibas.ch/fakultaet/angewandt/articles/Camerer_{—}2005.pdf); Cañas et al., “CmapTools: A knowledge modeling and sharing environment,” Proc. of the First Int. Conference on Concept Mapping, 2004 (http://cmc.ihmc.us/papers/cmc2004-283.pdf); Career Pathways, (http://www.michigan.gov/documents/pathways_{—}8310_{—}7.html); CareerOneStop Competency Model Clearinghouse (http://www.careeronestop.org/COMPETENCYMODEL/pyramid.aspx); CareerOneStop Homepage, last access June 2010 (http://www.careeronestop.org/); Cooper-Kahn and Dietzel, “Late, Lost, and Unprepared: A Parents' Guide to Helping Children with Executive Functioning,” Woodbine House, 2008; Cox, “No Mind Left Behind,” Perigee Books, 2007; Croxford, “Construction of social class variables,” ESRC Research Project Report, 2004 (http://www.ces.ed.ac.uk/PDF%20Files/EYT_WP04.pdf); Denissen and Penke, “Motivational individual reaction norms underlying the Five-Factor model of personality: First steps towards a theory-based conceptual framework,” Journal of Research in Personality, 2008 (http://www.psy.ed.ac.uk/people/lpenke/publications/Denissen_Penke_{—}2008_-_FIRNI.pdf); Deshon and Gillespie, “A Motivated Action Theory Account of Goal Orientation,” Journal of Applied Psychology, 2005 (http://faculty.washington.edu/mdj3/MGMT580/Readings/Week%207/Deshon.pdf); Dierdorff et al., “The Milieu of Managerial Work: An Integrative Framework Linking Work Context to Role Requirements,” Journal of Applied Psychology, 2009 (https://www.msu.edu/˜morgeson/dierdorff_rubin_morgeson_{—}2009.pdf); Engelbart, “Augmenting Human Intellect: A Conceptual Framework,” October 1962 (http://www.dougengelbart.org/pubs/augment-3906.html); Feldman, MIT Press, “From Molecule to Metaphor: A Natural Theory of Language” (2006 (http://www.m2mbook.org/reader-roadmap); Fields, “Career Renegade,” Broadway Books, 2009; FOMDD Homepage, “Feature Oriented Model Driven Development,” January 2007 (http://www.onekin.org/fomdd); Gaines and Shaw, “Rep V Manual,” March 2005 (http://repgrid.com/); Gaines and Shaw, “Knowledge Acquisition Tools based on Personal Construct Psychology,” The knowledge engineering review, 2009 (http://citeseerx.ist.psu.edu/viewdoc/download?doi=10.1.1.33.2205&rep=rep1&type=pdf); Ganzeboom et al., “A Standard International Socio-Economic Index of Occupational Status,” Social Science Research, 1992 (http://arno.uvt.nl/show.cgi?fid=63721); Germanakos et al., “Capturing Essential Intrinsic User Behaviour Values for the Design of Comprehensive Web-based Personalized Environments,” 2008 (http://old.media.uoa.gr/˜mourlas/publications/Capturing_Intrinsic_User_Behaviour_Values.pd); Gibson et al., “Holistic versus Decomposed Ratings of General Dimensions of Work Activity,” Conf. of Society for Industrial and Organizational Psychology, April 2004 (http://pstc.com/documents/2004SIOP_gibson_harvey_quintela.pdf); Goffman, “The Presentation of Self in Everyday Life,” Anchor Books, 1959; Goh and Goh, “The Role Of Analogy In Knowledge, Cognition And Problem-Based Learning,” 2006 (http://www.myrp.sg/ced/research/papers/tlhe2006/The_Role_of_Analogy_Goh_Goh_.pdf); Goldberg, “The Organized Student: Teaching Children the Skills for Success in School and Beyond,” Simon & Schuster, 2005; Grandin, “How does visual thinking work in the mind of a person with autism? A personal account,” 2009 (http://www.ncbi.nlm.nih.gov/pmc/articles/PMC2677580/pdf/rstb20080297.pdf); Grant, “A languishing-flourishing model of goal striving and mental health for coaching populations,” Int. Coaching Psych. Rev. (Vol. 2 No. 3), November 2007; Greif, “Advances in research on coaching outcomes,” Int. Coach. Psy. Rev. (V. 2 N. 3), 2007; Gros, “Cognition and Emotion: Perspectives of a Closing Gap,” Draft Copy, 2010 (http://arxiv.org/PS_cache/arxiv/pdf/1002/1002.3035v1.pdf); Gucciardi, “Mental Toughness in Australian Football,” Phd Dissertation, 2008 (http://theses.library.uwa.edu.au/adt-WU2009.0007/public/02whole.pdf); Haier et al, “Gray matter correlates of cognitive ability tests used for vocational guidance,” 2010 (http://www.biomedcentral.com/content/pdf/1756-0500-3-206.pdf); Harvey, “Construct Validity and the O*NET Holistic Rating Scales: Evidence of a Fundamental Lack of Discriminant Validity,” 2009 (http://harvey.psyc.vt.edu/Documents/jobanalysis/2009.04.20.NAS.Harvey.Paper3.constructvalidity.pdf); Harvey, “The O*NET: Do Too-Abstract Titles+Unverifiable Holistic Ratings+Questionable Raters+Low Agreement+Inadequate Sampling+Aggregation Bias=(a) Validity, (b) Reliability, (c) Utility, or (d) None of the Above?,” 2009, (http://harvey.psyc.vt.edu/Documents/jobanalysis/2009.04.12.FINAL.RJHarvey.NASpaper1.pdf); Heine, “Using Personal and Online Repertory Grid Methods for the Development of a Luxury Brand Personality,” The Electronic Journal of Business Research Methods Vol. 7 Issue 1 2009; Hollingshead, “Four Factor Index of Social Status,” Draft, 1975 (http://www.yale-university.com/sociology/faculty/docs/hollingshead_socStat4factor.pdf); Hoover, “Keys to Athletic Success: A Study of Student-athletes' and Coaches' Views on Mental Toughness,” Masters Thesis, Marietta College, 2006 (http://etd.ohiolink.edu/send-pdfcgi/Hoover%20Andrea%20Jane.pdf?marietta1147285443); IEAD, “Enterprise Architecture Validation,” Institute for Enterprise Architecture Developments (http://www.enterprise-architecture.info/Images/Extended%20Enterprise/Extended%20Enterprise%20Architecture2.htm); Ievleva and Terry, “Applying Sport Psychology to Business,” 2009 (http://eprints.usq.edu.au/4356/1/Ievleva_Trry.pdf); IfM and IBM, “Succeeding through service innovation: A service perspective for education, research, business and government,” 2008 (http://www.ifm.eng.cam.ac.uk/ssme/documents/080428ssi_us_letter.pdf); Ihde, “Experimental Phenomenology: An Introduction,” Putnam, 1986 (http://books.google.com/books?hl=en&lr=&id=5AYQEphi6DsC&oi=fnd&pg=PA7&dq=ihde+experimental+phenomenology&ots=EIfLuW4AxM&sig=W96I8eqZumOkV8jvvFES45qnGsM#v=onepage&q&f=false); Islandora Project, (http://islandora.ca/node/5, last accessed 29 May 2010); JEE, Journal of Evolutionary Economics, (http://www.springer.com/economics/journal/191); Kapoor et al., “Sense-and-respond supply chain using model-driven techniques,” 2007 (http://citeseerx.ist.psu.edu/viewdoc/download?doi=10.1.1.134.3540&rep=rep1&type=pdf); Kerruish, “Interpreting Feeling: Nietzsche on the Emotions and the Self,” 2009 (http://epubs.scu.edu.au/cgi/viewcontent.cgi?article=1457&context=sass_pubs); Khoury, “A unified approach to enterprise architecture modelling,” 2007 (http://hdl.handle.net/2100/597); Kim, “In search of a mental model-like concept for group-level modeling,” Systems Dynamic Review, July/September 2009 (http://onlinelibrary.wiley.com/doi/10.1002/sdr.422/abstract); Kim, “Visualizing Users, User Communities, and Usage Trends in Complex Information Systems Using Implicit Rating Data,” Dissertation, Virginia Polytechnic Institute and State University, 14 Apr. 2008 (http://scholar.lib.vt.edu/theses/available/etd-04252008-122316/unrestricted/SeonhoKim_Dissertation.pdf); Kirlik (Ed), “Adaptive Perspectives on Human-Technology Interaction,” New York: Oxford University Press, 2006; Kloo and Perner, “Training Theory of Mind and Executive Control,” Project Report, University of Salzburg (http://www.uni-salzburg.at/pls/portal/docs/1/550748.PDF); Knippel, “Service Oriented Enterprise Architecture,” November 2005, (http://knippel.org/thesis/SOEA_censored.pdf); Koch, “The Quest for Consciousness: A Neurobiological Approach,” Roberts & Co, March 2004; Kubesch et al., “A 30-Minute Physical Education Program Improves Students' Executive Attention,” Mind, Brain, and Education, Vol 3 No. 4, 2009 (http://www.uni-ulm.de/˜tkammer/pdf/Kubesch_{—}2009_MindBrainEducation.pdf); Lakoff and Johnson, “Metaphors We Live By,” 1980; Lardon, “Finding Your Zone,” Perigee Books, 2008; Laursen and Meliciani, “The role of ICT knowledge flows for international market share dynamics,” Res. Policy, 2010 (http://www.druid.dk/laursen/files/laursen_meliciani2010RP.pdf); LeDoux, “Emotion Circuits in the Brain,” Annu Rev. Neurosci. 2000. 23:155-184 (http://arjournals.annualreviews.org/doi/ab s/10.1146%2Fannurev.neuro.23.1.155); Lee, “The role of social class models in the relationship between socioeconomic status and academic achievement,” Dissertation, University of Minnesota, 2009 (http://conservancy.umn.edu/bitstream/52307/1/Lee_umn_{—}0130E_{—}10372.pdf); Leist and Zellner, “Evaluation of current architecture frameworks,” 2006 (http://portal.acm.org/citation.cfm?doid=1141277.1141635); Lele et al., “Sixearch.org 2.0: Peer Application for Collaborative Web Search,” HT 2009 Torino, Italy (https://www.cs.indiana.edu/˜lewu/mypapers/ht2009.pdf); Libosvar, “HIERARCHIES IN PRODUCTION MANAGEMENT AND CONTROL: A SURVEY,” 7 Jan. 1988 (http://dspace.mit.edu/bitstream/handle/1721.1/3037/P-1734-19477276.pdf;jsessionid=C3CF53170D249160D33064D09657BECA?sequence=1); Loehr, “The New Toughness Training for Sports,” Penguin Group, 1995; Lombardo, “The Evolution of Future Consciousness The Nature and Historical Development of the Human Capacity to Think about the Future,” AuthorHouse, 2006; Lombardo, “The Future Evolution of the Ecology of Mind,” World Future Review, February/March 2009 (http://online.printmailcom.com/drupal/upload/PDFWFR/WFR0902_Lombardo.pdf); Luo et al.,“Merging Textual Knowledge Represented by Element Fuzzy Cognitive Maps,” Journal of Software (Vol 5, No 2), February 2010 (http://www.academypublisher.com/ojs/index.php/jsw/article/viewFile/0502225234/1555); Ma and Yuen, “Learning News Writing Using Emergent Collaborative Writing Technology Wiki,” Workshop on Blended Learning, 2007, (http://www.cs.cityu.edu.hk/˜wbl2007/WBL2007_Proceedings_HTML/WBL2007_PP303-314_Ma.pdf); Mack, “Mind Gym: An Athletes Guide to Inner Excellence,” McGraw-Hill, 2001 Maglio et al., “Service systems, service scientists, SSME, and innovation,” July 2006 (http://doi.acm.org/10.1145/1139922.1139955); Malan, “The role of shared mental models of strategic thinking in the development of organisational strategy,” USQ Dissertation (2010; http://eprints.usq.edu.au/9387/2/Malan_{—}2010_whole.pdf); Marchiori, “W5: The Five W's of the World Wide Web,” 2000, (http://reference.kfupm.edu.sa/content/w/f/w5_the_five_w_s_of_the_world_wide_web_{—}62168.pdf); Martin et al., “Smarts: Are We Hardwired for Success?,” AMACOM, 2007 Martin, “Visual data mining in intrinsic hierarchical complex biodata,” PhD Dissertation, Bielefeld University, June 2009 (http://bieson.ub.uni-bielefeld.de/volltexte/2009/1514/pdf/doctoratPublish.pdf); McCloskey et al.,“Assessment and Intervention for Executive Function Difficulties,” Routledge (Taylor & Francis), 2009 (http://www.routledge.com); McDowall and Kurz, “Making the most of psychometric profiles—effective integration into the coaching process,” Int. Coaching Psych. Rev. (Vol. 2 No. 3), November 2007; Magalhaes et al., “Making Sense Of Enterprise Architectures As Tools Of Organizational Self-Awareness (OSA),” 2007 (https://doc.telin.nl/dsweb/GetNersion-59234/TEAR+2007+proceedings.pdf#page=65); Mellin, “The Solution: 6 winning ways to permanent weight loss,” Collins, 1997; Mellin, “Wired For Joy!: A Revolutionary Method for Creating Happiness from Within,” Hay House, 2010; Meltzer, “Promoting Executive Function in the Classroom,” Guilford Press, 2010; Milne and Witten, “An Open-Source Toolkit for Mining Wikipedia,” 2009 (http://wikipedia-miner.sourceforge.net/); Morgeson and Humphrey, “The Work Design Questionnaire (WDQ): Developing and Validating a Comprehensive Measure for Assessing Job Design and the Nature of Work,” Journal of Applied Psych., 2006 (http://test.scripts.psu.edu/users/s/e/seh25/Morgeson%20and%20Humphrey%202006.pdf); Mount et al., “Higher-order dimensions of the big five personality traits and the big six vocational interest types, Personnel Psychology, 2005 (http://www.uam.es/personalpdi/psicologia/pei/download/mount2005.pdf); MTurk, https://www.mturk.com/mturk/welcome, last accessed July 2010; NCBI PubMed Homepage, last access 30 Jun. 2010 (NCBI PubMed Homepage); NextPractice, “Nextpertiser,” 2008 (http://www.nextpractice.de); NIST ISD Homepage, NIST Manufacturing Engineering Laboratory: Intelligent Systems Division, last access June 2010, (http://www.nist.gov/mel/isd/); NSDL for Developers (http://nsdl.org/contribute/?pager=developers); NSDL Homepage, last access 30 Jun. 2010 (http://nsdl.org/); NSDL Science Literacy Maps, (http://strandmaps.nsdl.org/, last accessed 29 May 2010); O*NET Resource Center, (http://www.onetcenter.org/content.html); O'Brien, “The Production of Reality: Essays and Reading on Social Interaction (4th ed),” 2006; OEDB, “Online Education Database,” (http://oedb.org/); Passmore, “Addressing deficit performance through coaching—using motivational interviewing for performance improvement at work,” Int. Coach. Psy. Rev. (V. 2 N. 3), 2007; Peters, “Consciousness as Recursive, Spatiotemporal Self-Location,” 2009 (http://precedings.nature.com/documents/2444/version/2); Pdolefsky, “Analogical Scaffolding: Making Meaning in Physics through Representation and Analogy,” PhD Dissertation, 2008 (http://colorado.edu/physics/EducationIssues/podolefsky/Podolefsky_thesis_analogical_scaffolding_final.pdf); Podolefsky and Finkelstein, “Analogical Scaffolding and the Learning of Abstract Ideas in Physics: An example from electromagnetic waves,” 2007 (http://www.colorado.edu/physics/EducationIssues/analogy/podolefsky_finkelstein_analogical_scaffolding.pdf); Ponzetto and Poesio, “State-of-the-art NLP Approaches to Coreference Resolution: Theory and Practical Recipes,” 2009 (http://www.cl.uni-heidelberg.de/˜ponzetto/pubs/ponzetto09c.pdf); Posthuma et al., “Perceptual Speed and IQ Are Associated Through Common Genetic Factors,” Behavior Genetics, 2001 (http://www.springerlink.com/content/v23k73x46v4jm557/); Pressman, “Patent It Yourself (14th ed),” Nolo Press, 2009 (http://www.nolo.com/); Ramchandran, “The Neuropsychological Correlates Of Leadership Effectiveness,” PhD Dissertation, University of Iowa, 2011 (http://ituiowa.edu/cgi/viewcontent.cgi?article=2449&context=etd); Raviv, “Hands-on Inventive Solutions in Engineering Design,” 2001 (http://155.225.14.146/asee-se/proceedings/ASEE2001/2001089.pdf); RCS Homepage, “The Real-time Control Systems Architecture,” 2003 (http://www.isd.mel.nist.gov/projects/rcs/); Reddick, “Working memory capacity, perceptual speed, and fluid intelligence: an eye movement analysis,” Masters Thesis, Georgia Institute of Technology, December 2006 (http://smartech.gatech.edu/bitstream/1853/14015/1/redick_thomas_s_{—}200612_mast.pdf); Reggia et al., “The Maryland Large-Scale Integrated Neurocognitive Architecture,” March 2008 (http://www.dtic.mil/cgi-bin/GetTRDoc? AD=ADA481261&Location=U2&doc=GetTRDoc.pdf); Rogers and Szamosszegi, “Fair Use in the U.S. Economy: Economic Contribution of Industries Relying on Fair Use” (CCIA:2011; available online at ccianet.org); Rossett, “First Things Fast: A Handbook for Performance Analysis (2nd ed),” Wiley, 2009; Rouwette et al., “On evaluating the performance of problem structuring methods: an attempt at formulating a conceptual framework,” December 2007 (http://www.ru.nl/pub lish/p ages/516802/rouwetteconceptualmodelgmb.pdf); Runyan, “Delivering Business Insights with Reports and Dashboards,” Dreamforce 2009 (http://www.salesforce.com/dreamforce/DF09/pdfs/SALE004_Ball.pdf); Russell, “Core Affect and the Psychological Construction of Emotion,” Psychological Review, 2003 (http://www2.bc.edu/˜russehm/publications/psyc-rev2003.pdf); Ryan, “Opportunities and Obstacles—Incorporating Positive Psychology into Business Coaching,” (http://www.positiveinsights.co.uk/articles/DISSERTATION.pdf); Salesforce.com Homepage, last access June 2010 (http://www.salesforce.com/); Sastry and Reddy,“User Interface Design Principles for Digital Libraries,” International Journal of Web Applications, June 2009 (http://dirf.org/ijwa/v1n20109.pdf); SBA, “Business Planning,” U.S. Small Business Administration, Small Business Training Network, (http://www.sba.gov/training/businessplanning/index.html);SBA, “Employee Development Program,” U.S. Small Business Administration Standard Operating Procedure (SBA Form 989), 1997 (http://www.sba.gov/sops/3410/sop34103.pdf); SBA, “Microloans Help Small Businesses Start, Grow and Succeed,” U.S. SBA, 2009 (www.sba.gov/idc/groups/public/documents/sba_homepage/recovery_act_microloans.pdf); SBA, “Technology transfer and seed capital investments,” SBIC Technotes (No. 1), January 1998 (http://www.sba.gov/idc/groups/public/documents/sba_program_office/inv_sbic_tech1.pdf); Schroth, “The Service-Oriented Enterprise,” November 2007 (http://www.alexandria.unisg.ch/EXPORT/DL/40828.pdf); Scivescoweb, Home Page (last accessed June 2010, http://scivescoweb.eac-leipzig.de/); Selk, “10-Minute Toughness,” McGraw-Hill, 2009; Shams et al, “A Corpus-based Evaluation of a Domain-specific Text to Knowledge Mapping Prototype,” Journal of Computers, Vol. 5, No. 1, January 2010 (http://academypublisher.com/ojs/index.php/jcp/article/viewFile/05016980/1347); Sielis et al., “Definition and Implementation of the Conceptual Model for Context Awareness in idSpace v1,” Proj. Report, 16 Feb. 2009 (http://dspace.ou.nl/bitstream/1820/1833/1/idSpace%20D3.2%20final%20EC%2016-02-2009.pdf); Siemens and Tittenberger, “Handbook of Emerging Technologies for Learning” (March 2009; http://umanitoba.ca/learning_technologies/cetl/HETL.pdf); Schneider, “The Development of Metacognitive Knowledge in Children and Adolescents: Major Trends and Implications for Education,” 2008 (http://thrivingtoo.typepad.com/files/fulltext-1.pdf); SOCRADES Homepage, last access June 2010 (http://www.socrades.eu/Home/default.html); SOAC Homepage, SOA Consortium Home Page (http://www.soa-consortium.org/index.htm); SOAC White Paper, “SOA Executive Insight Report,” April 2007 (http://www.soa-consortium.org/Executive Insight whitepaper-2007.pdf); SOC Homepage, last access June 2010 (http://www.bls.gov/socf); Spohrer et al., “Steps Toward a Science of Service Systems,” 2007 (http://dret.net/lectures/ssme-spring07/MaglioReading.pdf); Squidoo, last access May 2010, (http://www.squidoo.com/squidoo); Stoet and Snyder, “Neural correlates of executive control functions in the monkey,” 2009 (http://www.ncbi.nlm.nih.gov/pmc/articles/PMC2825374/pdf/nihms-176705.pdf); Successfactors Homepage, last access June 2010 (http://www.successfactors.com/); Thagard, “How Brains Make Mental Models,” chapter in L. Magnani et al. (Eds.): Model-Based Reasoning in Science & Technology, SCI 314, pp. 447-461. (http://cogsci.uwaterloo.ca/Articles/Thagard.brains-models.2010.pdf); Tharp and Gallimore, “Rousing minds to life,” Cambridge University Press, 2002 (http://catdir.loc.gov/catdir/samples/cam031/88020224.pdf); Tristao et al., “FlowSpy: exploring Activity-Execution Patterns from Business Processes,” 2008 (http://seer.unirio.br/index.php/isys/article/viewFile/209/194); USPTO, “Resources and Guidance,” (http://www.uspto.gov/patents/resources/index.jsp); USPTO OCIO, “Lifecycle Management Manual,” 2007 (http://www.uspto.gov/web/offices/cio/lcm/lcm.htm); Vaillant, “Spiritual Evolution: How We Are Wired for Faith, Hope, and Love,” Broadway Books, 2008; Van Praag, “Exercise and the brain: something to chew on,” Trends in Neurosci, May 2009; Vinciarelli et al., “Social Signal Processing: Survey of an Emerging Domain,” 2009 (http://cites eerx.ist.psu.edu/viewdoc/download?doi=10.1.1.144.1913&rep=rep1&type=pdf); Wikipedia Miner, last access 30 Jun. 2010 (http://wikipedia-miner.sourceforge.net/); Wilcox et al., “The Okinawa Program,” Three Rivers Press, 2001; Williams, “Coaching Your Kids to Be Leaders: The Keys to Unlocking Their Potential,” Warner Books, 2005; Wolf, New York Times, “The Data-Driven Life” (14 Sep. 2010; http://www.nytimes.com/2010/05/02/magazine/02self-measurement-t.html?pagewanted=print#); Wong, “Multi-Layer Fuzzy Cognitive Modeling Using Fuzzy Signatures,” FUZZ-IEEE 2009, August 2009 (http://researchrepository.murdoch.edu.au/1368/1/Multi-layer_fuzzy.pdf); Wooden and Jamison, “Coach Wooden's Leadership Game Plan for Success,” McGraw, 2009; Wooden, “Pyramid of Success,” (http://www.coachwooden.com/pyramidpdf.pdf); WT, Wikipedia Topic (as listed in text; last accessed 2 Jun. 2012); Y. Boutalis et al., “Adaptive Estimation of Fuzzy Cognitive Maps with proven Stability and Parameter Convergence,” 2008 (http://staff.polito.it/enrico.canuto/Home_page/CorsoChristodoulou/TORINO_papers/FCM_revised_final.pdf); Yoshida et al., “Game Theory of Mind,” 2008 (http://www.ncbi.nlm.nih.gov/pmc/articles/PMC2596313/pdf/pcbi.1000254.pdf); Zhao et al., “Impact of Service-Centric Computing on Business and Education,” March 2008 (http://process.eller.arizona.edu/readings/CAIS08-SCC.pdf); Zhou and Cacioppo, “Culture and the brain: Opportunities and obstacles,” Asian Journal of Social Psychology (2010), 13, 59-71 (http://www3.interscience.wiley.com/cgi-bin/fulltext/123450279/PDFSTART); Zhou and Lee, “Causality interfaces for actor networks,” 2008 (http://doi.acm.org/10.1145/1347375.1347382)

1. A method for eliciting mental models, comprising:
(a) communicating predetermined representations of predetermined models and predetermined associations of elements of said models
(b) storing and retrieving information elements that incorporate information, or transformations of such information as provided by said communications of said representations
(c) interactively exchanging and manipulating said information elements
(d) synthesizing new elements
(e) wherein said new elements incorporate information derived from said interactive exchanges of elements, representations, or associations.
(e) whereby said communication, storage, retrieval, and synthesis operations enhance the working memory and executive functionality of said operator
(f) whereby said enhanced operator functionality and associated capabilities facilitate self-defining and self-improving of task performance of said operator.

2. The method for eliciting mental models of claim 1, comprising:
(a) pedagogical orientation with initial mental-model elicitation
(b) mental model elicitation for domains of interest
(c) clarification and synthesis of said elicited mental models
(d) production of knowledge artifacts
(e) whereby said knowledge artifacts represent transformations of said mental model elicitation and synthesis, thus incorporating information originally implicit in said mental models.

3. The method for eliciting mental models of claim 1,
(a) wherein said predetermined models and associated representations are selected from a group consisting of predetermined subgroups of predetermined representations and models
(b) wherein said predetermined subgroups are selected from the group comprising a plurality of the following domains: (a) Phenomenology and semiotics; (b) Emotions; (c) Genomics and genetics; (d) Physiology and endophenotypes; (e) Brain science; (f) Behavioral neuroscience; (g) Intelligent systems; (h) Systems Engineering; (i) Organizational theory; (j) Human development psychology; (k) Sports psychology; (l) Personal genomics, family genetics, personal history, family history, genealogy; (m) Values, interests, goals, objectives, plans, milestones, schedules, daily activities, education, vocations, occupations, industries, patents, knowledge, skills, abilities, user assessments.

4. The method for eliciting mental models of claim 1,
(a) wherein said elicitation operations comprise a method of assigning relationships
(b) wherein the operator dynamically designates a degree of said relationship, or concurrence with a predetermined designation and scoring of degree of relationship.

5. The method for eliciting mental models of claim 1,
(a) wherein said elicitation operations comprises presentation processing of said predetermined representations
(b) wherein said presentation processing comprises assigning relatedness scores between elements of said representations and a plurality of interactively selected predetermined topics stored within a predetermined repository
(c) whereby said relatedness scores are utilized for follow-on interactive discovery and elicitation of additional topics and associated types of representations.

6. The method for eliciting mental models of claim 1,
(a) wherein said elicitation operations include assigning said related topics and representations to clusters of said topics and representations
(b) wherein the clusters are hierarchically related.

7. The method for eliciting mental models of claim 1,
(a) wherein said elicitation operations include artificial intelligence (AI) methods or use of AI devices
(b) wherein said artificial intelligence (AI) methods are selected from a group comprising methods of emulation of human intelligence, methods of machine learning, and methods of knowledge processing.

8. A method for eliciting mental models of claim 1,
(a) wherein said elicitation operations facilitate interactive discovery and elicitation of (i) operator genomic predispositions, (ii) intrinsic values and interests, (iii) assessing of said operator capabilities, (iv) establishing goals and milestones
(b) whereby said discoveries and elicitations aid the transformation of said discoveries and elicitations into plans and support elements for executing and monitoring said plans.

9. The method for eliciting mental models of claim 1, wherein said elicitation comprises:
(a) discovering representations relating to neuroscience and genomics
(b) associating said discoveries to neuromuscular activity
(c) associating said associated discoveries with predetermined representations of other models and activities
(d) relating said combinations of discoveries, elicitations, and associations to operator specified interests, goals, and objectives
(e) whereby enabling an operator to transform individual instances of said representations into a blended representation
(f) whereby said relationships enable kinesthetic learning that pertains to the executive function and working memory aspects of neuromuscular activities
(g) whereby said neuromuscular activities comprise athletic sports activities.

10. An apparatus for eliciting mental models, comprising of:
(a) an electrical communications element (1002), a memory management element (1004), a logic and data processing element (1005), an operator interface data processing element (1012), a presentation processing of document data processing element (1014), and an education and demonstration element (1016)
(b) wherein said communications element (1002) communicates predetermined representations of predetermined models and predetermined associations of elements of said models through interconnectivity to said memory management element (1004), said logic and data processing element (1005), said operator interface element (1012), said presentation processing of document data processing element (1014), and said education and demonstration element (1016)
(c) wherein said communication events comprise of exchanges of information elements relating to said predetermined representations of said predetermined models and said predetermined associations of elements of said representations and models
(d) wherein said communication events comprises storing and retrieving information elements that incorporate information, or transformations of such information
(e) wherein said communication events comprises interactive exchanging and manipulating of said information elements
(f) wherein said communication events comprises synthesizing elements and representations
(g) wherein said new elements incorporate information derived from said interactive exchanges of elements, representations, or associations.
(h) whereby said communication, storage, retrieval, and synthesis operations enhance the working memory and executive functionality of said operator
(i) whereby said enhanced operator functionality and associated capabilities facilitate self-defining and self-improving of task performance of said operator.

11. The apparatus for eliciting mental models of claim 10, wherein the method of use comprises
(a) pedagogical orientation with initial mental-model elicitation
(b) mental model elicitation for domains of interest
(c) clarification and synthesis of said elicited mental models
(d) production of knowledge artifacts
(e) whereby said knowledge artifacts represent transformations of said mental model elicitation and synthesis, thus incorporating information originally implicit in said mental models.

12. The apparatus for eliciting mental models of claim 11,
(a) wherein said predetermined representations are selected from a group consisting of predetermined subgroups of representations
(b) wherein said predetermined subgroups are selected from the group comprising a plurality of the following domains: (i) phenomenology and semiotics; (ii) emotions; (iii) genomics and genetics; (iv) physiology and endophenotypes; (v) brain science; (vi) behavioral neuroscience; (vii) intelligent systems; (viii) systems engineering; (ix) organizational theory; (x) human development psychology; (xi) sports psychology; (xii) personal genomics, family genetics, personal history, family history, genealogy; (xiii) values, interests, goals, objectives, plans, milestones, schedules, daily activities, education, vocations, occupations, industries, patents, knowledge, skills, abilities, user assessments.

13. The apparatus for eliciting mental models of claim 10, wherein, wherein said elicitation functions include a method of selecting related prior art from a plurality of candidate references wherein the operator dynamically designates a degree of relationship, or concurrence with predetermined designation and scoring of degree of relationship, of information elements of said prior art to information elements of said candidate reference.

14. The apparatus for eliciting mental models of claim 10,
(a) wherein said elicitation operations include artificial intelligence (AI) methods or use of AI devices

15. The apparatus for eliciting mental models of claim 14, wherein said artificial intelligence (AI) methods are selected from a group comprising methods of emulation of human intelligence, methods of machine learning, and methods of knowledge processing.

16. The apparatus for eliciting mental models of claim 10, wherein said elicitation functions include updating and evolving associated elements and attributes of said representations by collectively integrating and storing said updated and evolved associations and their transitive relations.

17. The apparatus for eliciting mental models of claim 10, wherein said elicitation functions facilitate interactive discovery and elicitation of a plurality of the following: (a) operator genomic predispositions, (b) intrinsic values and interests, (c) assessing of said operator capabilities, (d) establishing goals and milestones, whereby said discoveries and elicitations aid the transformation of such knowledge into plans and supporting infrastructure for executing and monitoring said plans.

18. A method of building an apparatus for eliciting mental models, comprising:
(a) providing an electrical communications subelement
(b) providing a dynamically extensible information storage and retrieval subelement
(c) gathering representations of data models comprising of schema, schema elements, and related knowledge representation artifacts
(d) constructing association matrices that explicitly relate elements of said representations, data models and associations of said elements with a plurality of other model domains
(e) constructing memory elements comprising of said representations, data models, schema, schema elements, topics, and respective associations thereof
(f) providing operator interface subelements.

19. The method of building an apparatus for eliciting mental models of claim 18, comprising:
(a) gathering representations and data models comprising of schema and other knowledge representation artifacts relating to predetermined models selected from the group comprising a plurality of (i) genomics and related biochemical models; (ii) biomedical models; (iii) brain models including physiological, psychological, or behavioral subelements; (iv) cognitive function models comprising of executive function and working-memory subelements; (v) artificial intelligence models comprising machine learning and knowledge processing subelements; (vi) process models including business process and enterprise architecture models;
(b) constructing association matrices that explicitly relate elements of said data models and associations of said elements with topics selected from the group comprising genomic predispositions, cognitive function, personal history, family history, values, interests, goals, plans, milestones, schedules, activities, education, vocations, occupations, industries, knowledge, skills, and abilities.

20. The method of building an apparatus for eliciting mental models of claim 18, comprising methods of manufacturing domain specific knowledge repositories and associated operator resources from predetermined classification systems (CS), whereby said repositories concentrate on one or more of the preexisting domain nodes that are elements of the said CS.
